(19) United States
(12) Patent Application Publication
(10) Pub. No.: US 2020/0228932 A1
(43) Pub. Date: Jul. 16, 2020

(54) MESH COMMUNICATIONS NETWORK HAVING MESH PORTS

(71) Applicant: LEFT TECHNOLOGIES INC., Maple Ridge (CA)

(72) Inventors: Jason Bruce Ernst, Coquitlam (CA); Zehua Wang, Port Coquitlam (CA)

(21) Appl. No.: 16/641,358

(22) PCT Filed: Aug. 9, 2018
(86) PCT No.: PCT/CA2018/000151

§ 371 Date: Feb. 24, 2020

Related U.S. Application Data
(60) Provisional application No. 62/550,471, filed on Aug. 25, 2017.

(51) Int. Cl. H04W 4/06; H04W 12/08; G06F 9/445; G06F 8/65; G06F 9/54; G06F 11/36

(52) U.S. Cl. CPC H04W 4/06; H04W 12/08; G06F 9/445; H04W 84/18; G06F 9/541; G06F 11/362; G06F 8/65

(57) ABSTRACT

A method for communicating over a mesh network established between a plurality of devices is disclosed. Each device has a wireless radio and the method involves launching a mesh service on each device, the mesh service being operable to cause a processor circuit of the device to provide functionality for controlling the wireless radio for communication between devices over the mesh network. Each device has at least one application running on the device, the at least one application being associated with a mesh port, the mesh port being used to designate data transmissions as being associated with instances of a specific application running on at least some of the devices in the plurality of devices, the at least one application and the mesh service on each device being in data communication. The method also involves, in response to a specific application running on a device requesting the mesh service to provide access to the mesh network for communication via a specific mesh port, causing the mesh service to determine whether the specific application is authorized for communications on the specific mesh port, and if the specific application is authorized, processing requests from the application to communicate on the specific mesh port over the mesh network and forwarding data transmissions associated with the specific mesh port to the specific application, and if the specific application is not authorized, declining requests from the application to communicate on the specific mesh port over the mesh network and preventing access by the specific application to data transmissions associated with the specific mesh port.

### BACKGROUND

### 1. Field

This disclosure relates generally to communicating over a mesh network established between a plurality of networked devices.

### 2. Description of Related Art

A mesh network is a network in which devices cooperate to relay data between devices to create a network infrastructure. The devices may be wired or wirelessly networked. Mesh networks are typically dynamic in that devices join or leave the network on a continual basis and thus transmission of data over the network presents challenges not faced in conventional networks where a physical network infrastructure is provided to facilitate connection by devices in the general locality.

### SUMMARY

In accordance with one disclosed aspect there is provided a method for communicating over a mesh network established between a plurality of devices, each device having a wireless radio. The method involves launching a mesh service on each device, the mesh service being operable to cause a processor circuit of the device to provide functionality for controlling the wireless radio for communication between devices over the mesh network. Each device has at least one application running on the device, the at least one application being associated with a mesh port, the mesh port being used to designate data transmissions as being associated with instances of a specific application running on at least some of the devices in the plurality of devices, the at least one application and the mesh service on each device being in data communication. The method also involves, in response to a specific application running on a device requesting the mesh service to provide access to the mesh network for communication via a specific mesh port, causing the mesh service to determine whether the specific application is authorized for communications on the specific mesh port, and if the specific application is authorized, processing requests from the application to communicate on the specific mesh port over the mesh network and forwarding data transmissions associated with the specific mesh port to the specific application, and if the specific application is not authorized, declining requests from the application to communicate on the specific mesh port over the mesh network and preventing access by the specific application to data transmissions associated with the specific mesh port.

Launching the mesh service may involve launching the mesh service when booting an operating system on the device.

Launching the mesh service may involve, in response to the specific application being launched on a device, determining whether the mesh service is currently running on the device, and if the mesh service is not currently running, launching the mesh service on the device.

The method may involve, if the mesh service is currently running on the device, determining whether a mesh service version is current, and if not terminating the running mesh service and re-launching an updated mesh service.

The method may involve receiving program codes for updating the mesh service and, prior to updating the mesh service, reading a cryptographic code within the program codes and determining whether the cryptographic code accords with a cryptographic code previously stored on the device.

The mesh service may be launched by causing the processor circuit of the device to execute a mesh service set of computer readable instructions included within an application set of computer readable instructions that are executed by the processor circuit for launching the specific application.

An operating system run by the processor circuit of each device may be operably configured to provide separated functionality for running services on the device, and the method may involve running the mesh service using the separated functionality for running services and limiting access by applications to the separated functionality for running services on the device.

Each mesh port may be associated with a unique mesh port identifier.

Each specific application may be associated with a unique application identifier and causing the mesh service to determine whether the specific application is authorized for communications on the specific mesh port may involve receiving the application identifier from the specific application, determining whether the application identifier matches an application identifier in a stored listing of authorized application identifiers and associated mesh ports in a memory location not accessible by the specific application.

The application identifier may include a digital signature.

In response to receiving a data transmission at mesh service running on a specific device that is associated with a mesh port for an application that is not currently running on the device, causing the mesh service to forward the data transmission over the mesh network while preventing access to the data transmission by other applications running on the device.

In response to receiving a data transmission at mesh service running on a specific device that is associated with a mesh port for a specific application that is currently running on the device, causing the mesh service to forward the data transmission to the application, forward the data transmission over the mesh network to other devices.

The wireless radio on each device may be operable to communicate over the mesh network using any of a plurality of wireless transmission links, and may further involve causing the mesh service to provide access for receiving user preferences for enabling or disabling access to at least some of the plurality of wireless transmission links for mesh network communications.

The method may involve, in response to receiving a data transmission at the mesh service on each device, determining whether the data transmission includes data related to controlling mesh network communications, and in response to determining that the data transmission includes data related to controlling mesh network communications, assigning the data transmission a higher transmission priority than other data transmissions.

Assigning the data transmission a higher transmission priority may involve assigning a highest transmission priority to data acknowledging receipt of previous transmissions by any of the plurality of devices, data associated with an application being launched on a device for accessing the mesh network, data associated with an application being terminated on a device.

Each specific application may include a set of application interface codes for directing the processor circuit on the device to interface with the mesh service for transmission of data between the application and the mesh service.

The mesh service may be operable to provide debugging functionality for application developers developing applications using the mesh network, and may further involve causing the mesh service to limit the debugging functionality to application developers providing a valid developer key signature.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

To be completed . . . .

FIG. 1 is a schematic view of a mesh network established between a plurality of devices;

FIG. 2 is a block diagram of a processor circuit for implementing the devices shown in FIG. 1;

FIG. 3 is a schematic diagram of functional blocks implemented on the devices shown in FIG. 1;

FIG. 4 is a flowchart depicting blocks of code for directing the processor circuit of FIG. 2 to launch and configure the functional blocks shown in FIG. 3;

FIG. 5 is a screenshot of a user interface displayed on any of the plurality of devices shown in FIG. 1;

FIG. 6 is a flowchart depicting blocks of code for directing the processor circuit of FIG. 2 to launch a mesh service on the devices shown in FIG. 1;

FIG. 7 is a schematic view of a portion of the mesh network shown in FIG. 1;

FIG. 8A,B is a flowchart depicting blocks of code for directing the processor circuit of FIG. 2 to implement an application event handling process;

FIG. 9 is a schematic view depicting a content data transmission;

FIG. 10A,B is a flowchart depicting blocks of code for directing the processor circuit of FIG. 2 to implement an mesh service event handler;

FIG. 11A-E is a flowchart depicting blocks of code for directing the processor circuit of FIG. 2 to implement a reliable transmission protocol on the mesh network shown in FIG. 1;

FIG. 12 is schematic view depicting an example of a data packet transmitted over the mesh network shown in FIG. 1; and

FIG. 13 is a flowchart depicting blocks of code for directing the processor circuit of FIG. 2 to implement a multicast transmission protocol on the mesh network shown in FIG. 1.

### DETAILED DESCRIPTION

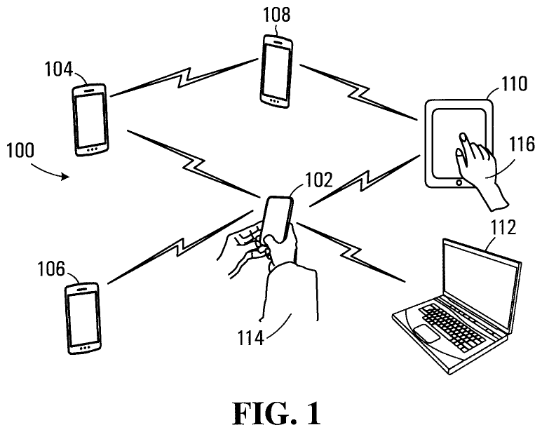

Referring to FIG. 1, a mesh network established between a plurality of devices is shown generally at 100. In the embodiment shown in FIG. 1 mesh network includes a first device 102, a second device 104, a third device 106, and a fourth device 112. In the embodiment shown the devices 102, 104, 106 and 108 are smartphone devices and may be running a smartphone operating system such as Android™ made available by Google of Mountain View, Calif. or any other suitable operating system. In this embodiment the first device 102 is being operated by a user 114. Additional devices are also participating in the mesh network 100 including a tablet computer 110 being operated by a user 116 and a laptop computer 112, each having a wireless radio. In other embodiments the devices 102-112 may be any of a plurality of networked devices such as smartphones, tablets or laptop computers, desktop computers, stand-alone networking devices such as a router or access point, computer peripherals such as a printer, and/or physical objects such as a networked appliance, for example. Other devices (not shown) that have wired connections may also participate in the mesh network although such devices may assume different network roles than the devices shown in FIG. 1. In general each of the devices 102-112 has an application loaded in the form of computer readable instructions that cause the respective devices to provide functionality for establishing the mesh network. In the mesh network 100, the device 102 is in wireless communication with each of the devices 104, 106, 110, and 112. Additionally the devices 104 and 110 are connected wirelessly through the device 108. Various other wireless links may be established within the mesh network 100 depending on the capabilities of the devices 102-112 and their geographic location with respect to each other.

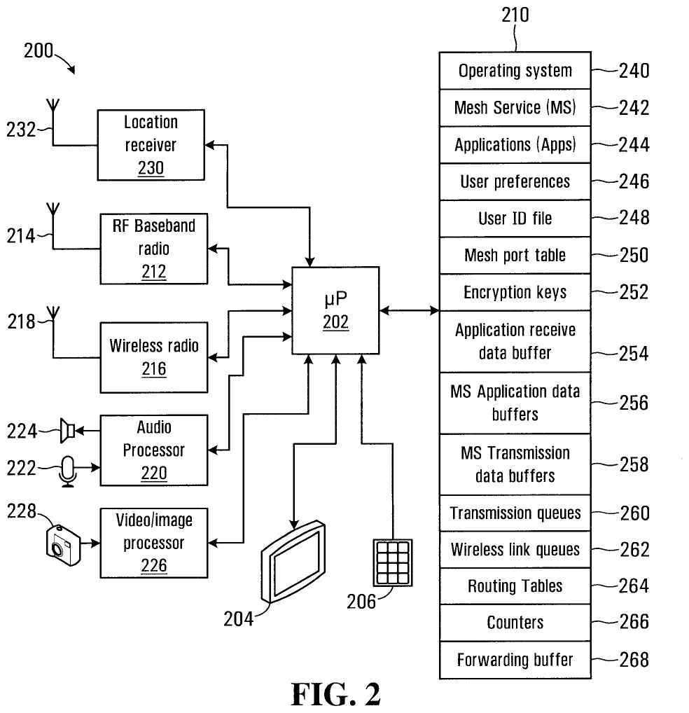

A block diagram of a processor circuit for implementing any of the devices 102-112 is shown in FIG. 2 at 200. Referring to FIG. 2, the processor circuit 200 includes a microprocessor 202, which may include multiple processing cores. The processor circuit 200 also includes a display 204 and an input device 206 for receiving user input. In some embodiments the input device 206 may be provided as touch screen on the display 204. In this embodiment the processor circuit 200 includes a memory 210 for storing data associated with applications that are running on the device. The memory 210 may be implemented using random access memory, non-volatile flash memory, a hard drive or combination of these and other memory types. The memory 210 is used for storing program codes and/or data and in the embodiment shown includes an operating system storage location 240, a mesh service storage location 280 for storing mesh service program codes, an application storage location 244 for storing application program codes, a user preferences location 246, a user identifier (uuid) file location 248, a mesh port table location 250, an encryption key storage location 252, a mesh service application data buffer location 256, a mesh service transmission data buffer location 258, a mesh service transmission queue location 260, a wireless link queue location 262, a routing table location 264, in a counters location 266, and a forwarding buffer location 268.

The processor circuit 200 further includes a RF baseband radio 212 and antenna 214 for connecting to a mobile telecommunications network. The RF baseband radio 212 may be configured to provide data communications using any of a variety of communications standards including 2G, 3G, 4G, or other communications standards.

The processor circuit 200 also includes a wireless radio 216 and antenna 218 for connecting to local networks such as an IEEE 802.11 WLAN local network. The wireless radio 216 may also provide for connections via other wireless links or protocols, such as Bluetooth, Wi-Fi Direct, or near-field communication.

The processor circuit 200 further optionally includes a location receiver 230. The location receiver 230 includes an antenna 218 for receiving global positioning system (GPS) signals and the location receiver 230 may use the GPS information in combination with other location information such as a known location of a particular local network access point or cellular signal triangulation information provided by a cellular service provider to determine a location of the networked device.

The processor circuit 200 further includes an audio processor 220, a microphone 222, and a speaker 224. The audio processor 220 receives and processes audio input signals from a microphone 222 and produces audio outputs at a speaker 224. The processor circuit 200 also includes a video/image processor 226 and a camera 228. The video/image processor 226 receives and processes image and/or video signals from the camera 228.

The display 204, input device 206, memory 210, RF baseband radio 212, wireless radio 216, audio processor 220, and video/image processor 226 are all in communication with the microprocessor 202.

The operating system storage location 240 stores codes for directing the microprocessor 202 to implement an operating system, which for the smartphone devices 102-106 may be an Android™ based operating system, an iOS based operating system, or any other operating system. The tablet computer 110 and laptop computer 112 may be running an Android, iOS, Windows®, Linux, or other suitable operating system. The remaining disclosure herein generally relates to implementations of the various disclosed embodiments under the Android based operating system, but the same principles also apply to other operating systems with some implementation differences.

The devices 102-108 may each be implemented using the processor circuit 200 very similar to that shown in FIG. 2. The laptop computer device 112 may include many of the components shown in FIG. 2, with some components possibly omitted such as the location receiver 230 and RF baseband radio 212 although these components may nevertheless be included in the laptop computer. While embodiments are described herein with reference to the processor circuit 200 architecture in FIG. 2, the described system embodiments and/or process embodiment are also applicable to communications between other types of devices. In general each of the devices 102-112 has computer readable codes loaded into flash memory 210 (or other memory type) that cause the respective devices to provide necessary functionality for establishing the mesh network 100. In some embodiments devices participating in the mesh network 100 may omit several of the components shown in FIG. 2. For example, a device may be incorporated as a connected device within a smart appliance, vehicle, or other physical object and may not include elements such as the display 204, input device 206, or other depicted components in FIG. 2. The connected device may, for example, be capable of executing java, c, or c⁺⁺ codes and may include a wireless radio 216 implementing IEEE 802.11, Bluetooth, Wi-Fi Direct, or near-field communication protocols for establishing wireless links.

In one embodiment the mesh network 100 may be established generally as disclosed in commonly owned patent U.S. provisional patent application 62/343,056 filed on May 30, 2016 entitled “METHOD FOR ESTABLISHING NETWORK CLUSTERS BETWEEN NETWORKED DEVICES”, incorporated herein by reference in its entirety. As such, devices in the mesh network 100 may be configured to act either as access points, clients, or routers. The access point devices (also referred to herein as “master mode”) permit other devices configured as clients (also referred to herein as “client mode”) to connect to the access points to receive and transmit data via the access point to other clients in the mesh network 100. Some client devices are further configured as routers (herein also referred to as “routing mode”) and are operable to provide a link between two devices configured in access point mode by alternating between connecting to each of the access points.

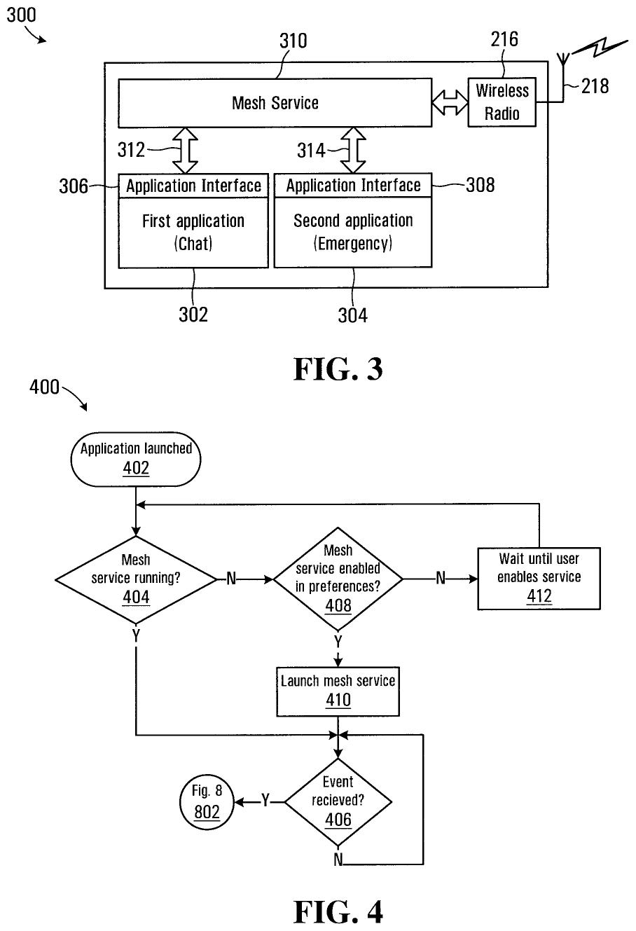

Referring to FIG. 3, a schematic diagram of functional blocks implemented on any of the devices shown in FIG. 1 for interacting with a mesh network is shown at 300. Blocks in the functional block diagram for the device 300 represent computer readable codes that direct the microprocessor 202 of the processor circuit 200 to implement the necessary functionality on the device for implementing the respective functions. In the embodiment shown, a first application 302 and a second application 304 are shown as running on the device and may implement functionality on the device for performing a variety of tasks, such as sharing content, chat, emergency service contact information, etc. In the embodiment shown the first application 302 is a chat application and the second application 304 is an emergency application. The application 302 has an application interface 306, which is in communication with a mesh service 310 running on the device. Similarly the second application 304 has an application interface 308, which is in communication with a mesh service 310 running on the device. The mesh service 310 causes the microprocessor 202 of the processor circuit 200 to control the wireless radio 216 for communication between devices over the mesh network 100. There is only a single mesh service 310 running on the device and in communication with both applications 302 and 304 (and any additional applications that are running on the device).

Referring to FIG. 4, a flowchart depicting blocks of code for directing the processor circuit 202 of the device to launch and configure the functional blocks shown in FIG. 3 is shown generally at 400. The blocks in FIG. 4 generally represent codes that may be read from the memory 210 for directing the microprocessor 202 to implement the functional blocks shown in FIG. 3. The actual code to implement each block may be written in any suitable program language, such as such as Java, C, Objective-C, C++, C#, and/or assembly code, for example. The process begins at block 402, which directs the microprocessor 202 to launch the application (in this case the first application 302) by executing the computer readable codes for the first application stored in the application storage location 244. When the application is launched, the application interface 306 for the first application 302 reads a cryptographic code or signature that is stored in the computer readable codes in the application storage location 244. The cryptographic code may be obtained by a developer of the first application when receiving a set of software developer tools including a library of functions that can be used to implement the mesh service functionality for an application. As such the cryptographic code may be included as part of the computer readable codes read from the application storage location 244 that are used to run the application on the device 300.

Block 404 then directs the microprocessor 202 to determine whether the mesh service 310 is already running on the device. If the mesh service 310 is already running then block 404 directs the microprocessor 202 to block 406, which directs the microprocessor to wait for an event.

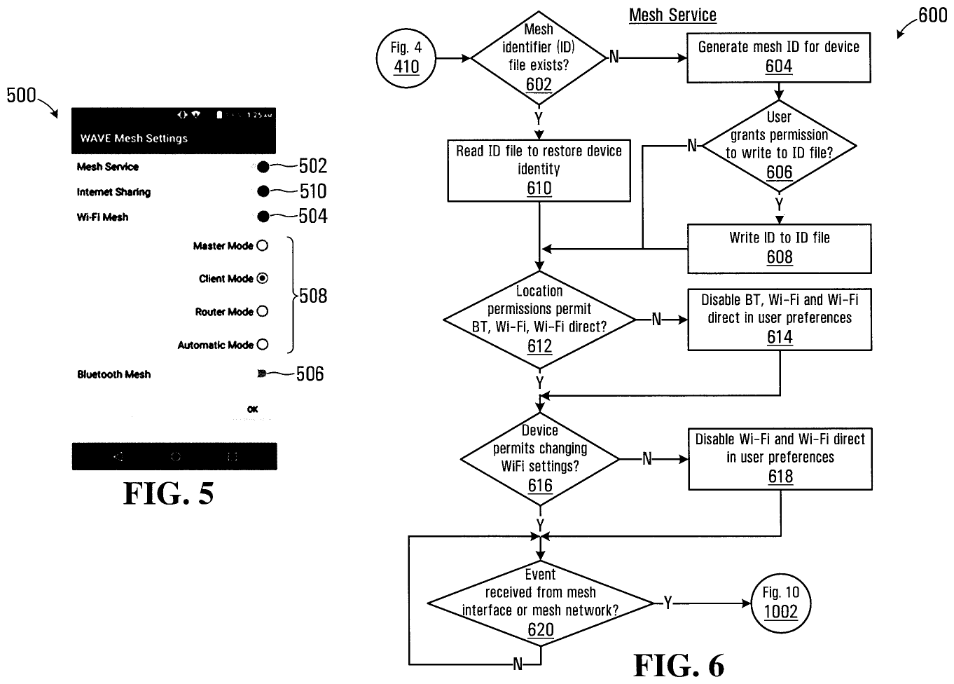

If at block 404 the mesh service 310 is not yet running on the device, block 404 directs the microprocessor 202 to block 408, which directs the microprocessor to determine whether the mesh service is enabled on the device. Referring to FIG. 5, a screenshot displayed on the device of a user interface for controlling user preferences is shown at 500. The user preferences interface 500 includes a “Mesh Service” control 502 that permits a user of the device to set a preference as to whether the mesh service 310 is enabled or disabled (the “Mesh Service” control is shown as enabled in FIG. 5). The user preferences interface 500 also includes other user preference controls including a “Wi-Fi mesh” control 504, a “Bluetooth Mesh” control 506, and a network role selector 508 including radio buttons for selecting between “master mode”, “Client mode”, “Router mode” and “Automatic mode”. The user preferences interface 500 also includes an internet sharing control 510 for indicating whether the user wishes to share a connection to the internet. For example, the RF baseband radio 212 or other interface on one of the devices may provide access to the internet over a data network, and the user may elect to share this access with other devices on the mesh network 100.

User preferences are received at the user preferences interface 500 and stored in the user preferences location 246 of the memory 210. Referring back to FIG. 4, block 408 thus directs the microprocessor to read the state of the “Mesh Service” control stored in the user preferences location 246, and if enabled directs the microprocessor to block 410. Block 410 directs the microprocessor 202 to launch the mesh service 310 by executing the mesh service program codes stored in the mesh service storage location 280. Block 405 also directs the microprocessor 202 to connect to the mesh service 310 and exchange the signature. The process then continues at block 406, which directs the microprocessor 202 to await the next event.

In the embodiment shown, the mesh service 310 is launched as a service on the device, which refers to software functionality that can be used by more than one application. The processor circuit 200 may run services in a mode that is protected from access by applications to prevent corruption and/or prohibited access to the service. The service may provide functionality to applications via an application programming interface (API) that exposes the functionality provided by the service for use by the applications.

If at block 408, the state of the “Mesh Service” control stored in the user preferences location 246 is disabled, the microprocessor is directed to block 412 to wait for the service to be enabled by the user. Connectivity to the mesh network 100 is thus suspended until the user changes the state of the “Mesh Service” control 502 to enabled. The application may however continue to perform offline functions. When the microprocessor 202 detects that the “Mesh Service” control 502 has been enabled, the microprocessor is directed back to block 404.

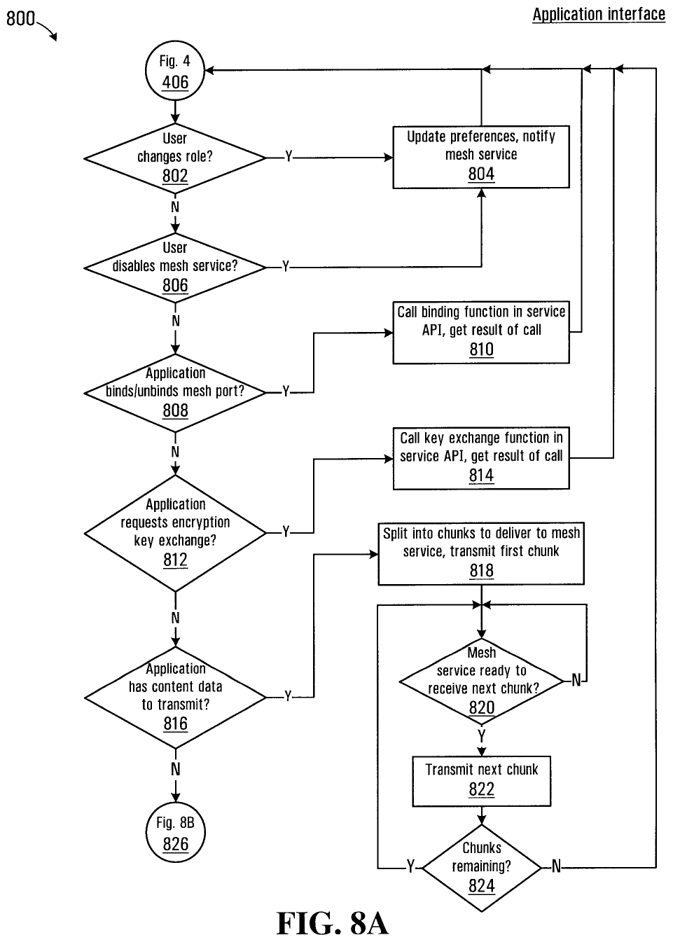

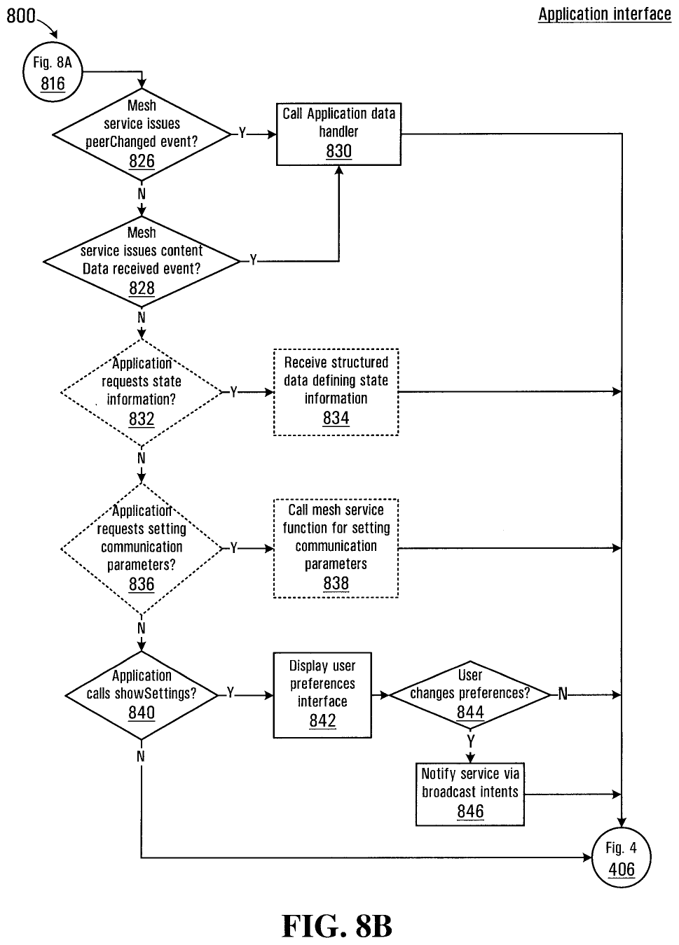

Block 406 directs the microprocessor 202 to determine whether an event has been received. If no event is received, the microprocessor 202 is directed to repeat block 406. If at block 406, an event is detected, block 406 directs the microprocessor 202 to block 802 of an application event handling process 800 shown in FIG. 8.

In the embodiment shown in FIG. 4, the launching of the mesh service 310 is thus in response to a specific application (in this case the first application 302) being launched on the device. If the mesh service 310 is not currently running, the mesh service is launched on the device if user preferences are set to enable the mesh service to run. In another embodiment, the mesh service 310 may be launched when booting the operating system of the device (i.e. from the operating system storage location 240 in memory 210).

In one embodiment, the mesh service program codes stored in the mesh service storage location 280 may be provided along with or as part of the application codes associated with either or both applications 302 and 304. If the mesh service 310 is found at block 404 to be currently running on the device, the process 400 may additionally involve determining whether a running mesh service version is current. If the version is not current, the running version of the mesh service 310 may be terminated and block 410 may be repeated to re-launch an updated mesh service. As an example, the second application 304 may have been downloaded to the memory 210 before the first application 302, and the first application may thus be packaged with an updated version of the mesh service 310. Alternatively program codes for an updated version of the first application 302 may be received and installed on the device 300 and the updated program codes may include updated mesh service program codes. An advantage is thus associated with disseminating the mesh service program codes along with the application codes, in that updates to the mesh service may be automatically rolled out to devices loading new applications.

Referring back to FIG. 3, inter-process communication between the application interfaces 306 and 308 and the mesh service 310 is represented by arrows 312 and 314. These inter-process communications 312 are dependent on the operating system running on the device and may be implemented using one or more protocols associated with the device. For example, under the Android operating system there are four different protocols that may be used for inter-process communications between the mesh service 310 and the application interfaces 306 and 308. On Android based devices, a process cannot directly access the memory allocated to another process and communications between processes must be conducted using operating system provided functions and protocols.

A first protocol known as broadcast intents (specific to the Android platform) may be used to transmit small amounts of data between the application interfaces 306 and 308 and the mesh service 310 when a user has disabled Wi-Fi or enabled Bluetooth, or changed other permissions on the user preferences interface 500, for example. Other operating system platforms provide similarly functioning protocols, for example a POSIX message queue for the Linux operating system, thread Messages, or Microsoft message queuing for the Windows operating system.

A second communication protocol for exchanging data between the application interfaces 306 and 308 and the mesh service 310 is through a messenger send/recv function used for larger data exchanges, such as lists of other devices that may be running the same application. The send/recv function may also be used for exchanging content data to be transmitted by the mesh service 310 or for data received at the application interfaces 306 and 308 from the mesh service. The size of data transfer using the messenger send/recv function is generally limited and larger exchanges of content data would need to be split up and transmitted using a plurality of messages (i.e. packetized).

A third communication protocol uses a common SQLite (SQL) database or a file to exchange data, allowing for faster data transmission since the database or file is stored in a commonly accessible location in the memory 210 and may be read by either the mesh service 310 or the application interfaces 306 or 308. The SQLite protocol may be effective in exchanging content data having larger file size, for example video or larger image content data. Using SQL or a file to exchange data also has the advantage of providing persistent storage of the data, which is an advantage if the mesh service 310 is shut down. Under the above messenger send/recv protocol, data that has not yet been transmitted by the mesh service 310, may be lost if the service is shut down for some reason.

In one embodiment the send/recv protocol may be used until communication rates over the mesh network 100 are sufficiently high that the use of this protocol for transferring data between the application interfaces 306 and 308 and the mesh service 310 causes a transmission bottleneck. In such cases, the third communication protocol may be used to remove the transmission bottleneck.

A fourth protocol known as Android Interface Definition Language (AIDL) may be used as an alternative to the messenger send/recv function for data exchanges such as lists of other devices that may be running the same application or lists of files to send, for example.

Referring to FIG. 6, a process executed by the mesh service 310 after the first application 302 directs the microprocessor 202 to launch the mesh service at block 410 of the process 400 is shown at 600. The process begins at block 602, which directs the microprocessor 202 of the device to determine whether a mesh network identifier (uuid) file exists stored on the device on the uuid storage location 248 in memory 210. If no uuid file exists, block 602 directs the microprocessor 202 to block 604, which directs the microprocessor to generate a mesh network identifier for the device. In one embodiment, the uuid may be generated using a blockchain compatible uuid generator that provides a very high likelihood that the resulting identifier will be unique. Block 606 then directs the microprocessor 202 to request the user to grant access for writing a uuid file into the uuid storage location 248 of memory 210. If permission is not granted by the user at block 606, the microprocessor 202 is directed to block 612 and the session continues with the generated uuid. However, if permission is not grated, a subsequent session initiated by the user of the device would again require generation of a uuid, which would be different from the currently active uuid.

If permission is granted by the user at block 606 to write the uuid to the uuid storage location 248, the microprocessor 202 is directed to block 608 and the uuid is saved to the memory 210. As long as the user doesn't delete the uuid file the stored uuid will remain available for use even if the applications 302 and 304 are removed. If the user subsequently installs a new application for use with the mesh network 100, the uuid remains available for use. In one embodiment the uuid may be stored in the uuid storage location 248 as an Ethereum compatible encrypted wallet. Block 608 then directs the microprocessor 202 to block 612.

Block 612 directs the microprocessor 202 to determine whether location permissions that are set on the device permit access to the mesh network 100 via Wi-Fi, Wi-Fi Direct, and Bluetooth wireless protocols. If access is not permitted, block 612 directs the microprocessor 202 to block 614 and the Wi-Fi, Wi-Fi Direct, and Bluetooth user preferences are saved to the user preferences location 246 of memory 210. Referring back to FIG. 5, this corresponds to setting the “Wi-Fi mesh” control 504 to disabled and the “Bluetooth Mesh” control 506 to disabled in the user preferences interface 500. If at block 612 access is permitted, block 612 directs the microprocessor 202 to block 616.

Block 616 directs the microprocessor 202 to determine whether the device has an operating system version that permits changing of Wi-Fi communication settings and whether the user has permitted changing of these settings on the device. For example, Android versions 5.x and higher permit changing of Wi-Fi settings but require that the user grant permission to make such changes. Since the establishment of the mesh network 100 requires manipulation of certain settings of the device and wireless radio 216, when access to these settings is disabled the device may be limited to connecting with the mesh network only via Bluetooth. If at block 616 changing of Wi-Fi settings is not permitted, the process continues at block 618 where the microprocessor 202 is directed to disable Wi-Fi and Wi-Fi direct communications via the wireless radio 216. This corresponds to setting the “Wi-Fi mesh” control 504 to disabled in the user preferences interface 500 shown in FIG. 5.

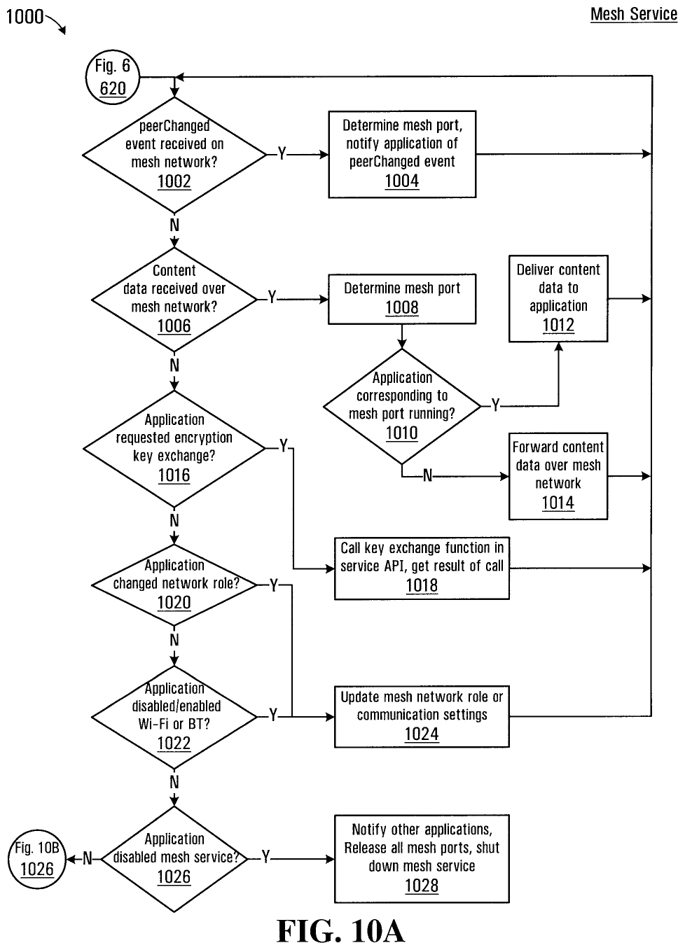

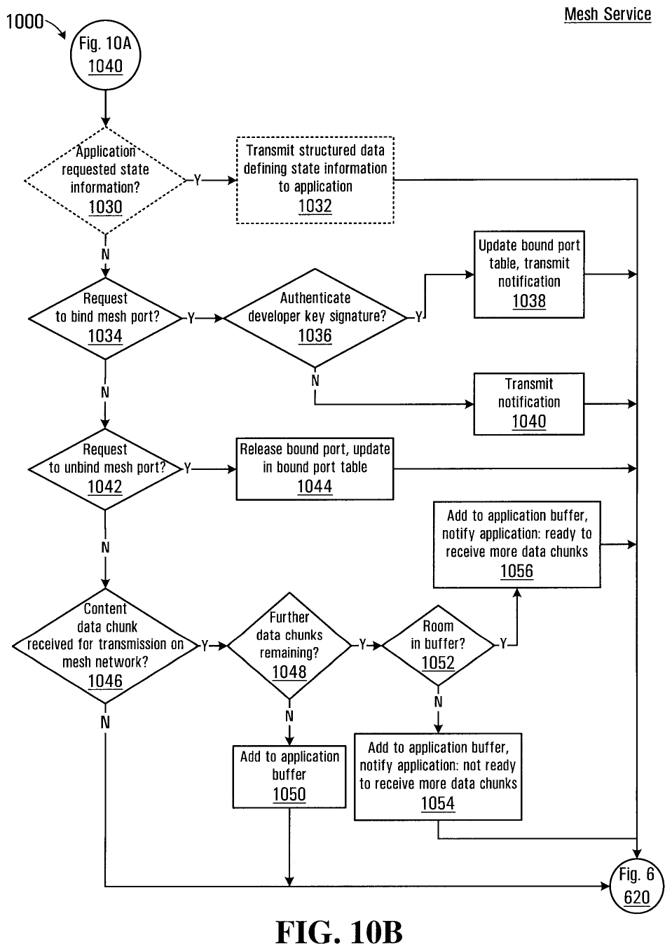

If at block 616 changing of Wi-Fi settings is permitted, the process continues at block 620, which directs the microprocessor 202 to determine whether an event has been received from either of the application interfaces 306 or 308 (FIG. 3) or from the mesh network 100 via the wireless radio 216. If no event is received, the microprocessor 202 is directed to repeat block 620. If an event is received, block 620 directs the microprocessor 202 to block 1002 of FIG. 10.

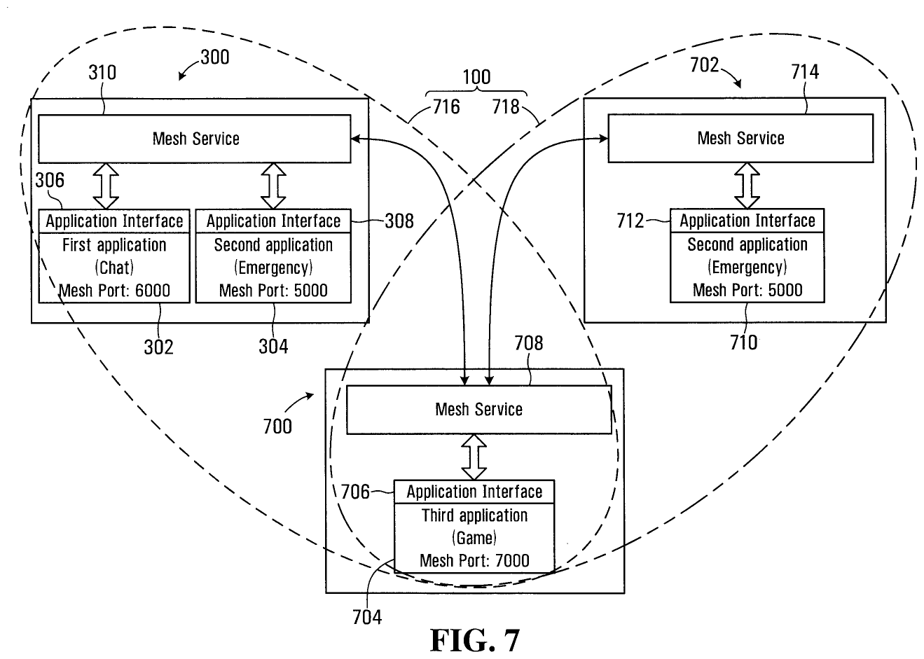

One advantage of the device configuration shown in FIG. 3 is provided by further uniquely identifying data flows associated with a particular application to permit separation of data traffic associated with specific applications (for example the first application 302 and second application 304 in the functional block diagram for the device 300 shown in FIG. 3). The device 300 shown in FIG. 3 is shown in FIG. 7 in communication with other devices over the mesh network 100. Referring to FIG. 7, the device 300 is in wireless communication with a device 700, which is in communication with a device 702. The device 300 is running both the first application 302 and second application 304, while the device 702 is only running an instance 710 of the second application. The device 700 is running a third application 704 related to a game played by networked devices over the mesh network 100. In FIG. 7, the devices 300 and 700 are within a wireless communications range 716, while the devices 700 and 702 are within a wireless communications range 718. However in the embodiment shown the devices 300 and 702 are out of wireless communications range. The wireless communications ranges 716 and 718 thus define the mesh network 100, in this case comprising 3 devices.

In the embodiment shown in FIG. 7, the mesh service 310 of the device 300 and the mesh service 714 running on the device 702 must therefore communicate data intended for transmission between the second applications 304 and 710 via the mesh service 714. In this embodiment, each data flow is associated with an identifier that provides a means for identifying which specific application a data transmission is associated with. In this disclosure the identifier is termed a “mesh port” and the first application is assigned a mesh port 6000, the second application is assigned a mesh port 5000, and the third application is assigned a mesh port 7000. The assigned mesh ports allow data flows associated with the instance of the second application 304 running on the device 300 to be forwarded only to the instance of the second application 710 running on the device 702. The mesh service 708 running on the device 700 receiving data having a mesh port of 5000, would still forward the data to the device 702, but would not forward the data to the third application 704 running on the device 700. The device 700 thus participates on the mesh network 100, but the third application 704 will not receive any data unless either another device running an instance of the third application 704 joins the mesh network 100 or one of the devices 300 or 702 launches an instance of the third application. This has the advantage of only providing relevant data to each of the first, second and third applications over the mesh network 100. Additionally, if the third application 704 attempts to listen on one of the mesh ports 5000 or 6000, the mesh service 708 running on the device 700 will prohibit such access.

An application event handling process executed by processor circuit 200 in handling events received at block 406 of the process 400 is shown in FIG. 8 generally at 800. The application event handling process 800 is described with reference to the device 300, but the same process is also run on each of the devices 700 and 702. The application event handling process 800 configures the application interfaces 306 and 308 of the device 300 to provide functionality for handling events. Various events may be received by the application interfaces 306 and 308 from either the mesh service 310 or from the first or second applications 302 and 304. Referring to FIG. 8A, the application event handling process 800 commences at block 802, which directs the microprocessor 202 to determine whether the user has changed user preferences stored in the user preferences location 246 associated with the mode in which the device operates. Referring back to FIG. 5, the user preferences interface 500 includes a plurality of button controls 508 that permit the user to select a network role for the device in the mesh network 100. The user may select between operating in master mode (i.e. as a Wi-Fi access point), in client mode, in routing mode, or in automatic mode. If a change in network role is detected by the microprocessor 202 at block 802, the microprocessor is directed to block 804. Block 804 directs the microprocessor 202 to save the changed user preference for the network role in the mesh network 100 to the user preferences location 246 in memory 210. Block 804 also directs the microprocessor 202 to communicate the change in network role to the mesh service 310 via the broadcast intents protocol. The process then returns to block 406 of the process 400 where the microprocessor 202 is directed to await the next event.

If no change in network role is detected at block 802, the process continues at block 806, which directs the microprocessor 202 to determine whether the user has disabled the mesh service 310. If the mesh service 310 has been disabled by the user at block 806, the microprocessor 202 id directed back to block 804 where the user preferences stored in the user preferences location 246 are updated and the mesh service 310 is notified of the change via a broadcast intents protocol message. The process then returns to block 406 of the process 400 where the microprocessor 202 is directed to await the next event.

If the mesh service 310 is not disabled at block 806, the process continues at block 808 which directs the microprocessor 202 to determine whether the application has requested binding or unbinding of a mesh port. As noted above, the first application 302 is configured for communication on a mesh port 6000 while the second application 304 is configured for communication on a mesh port 5000. If, for example, the first application 302 requests binding to the mesh port 6000, block 808 directs the microprocessor 202 to block 810. Block 810 then directs the microprocessor 202 to call a mesh port binding API function provided by the mesh service 310 to request binding on mesh port 6000.

Applications such as the applications 302, 304, and 704 may be produced by a variety of different application developers and made available to users of the mesh network 100. In one embodiment, each application developer is required to go through a registration process before being permitted to provide applications for use on the mesh network 100. When registering, the application developer in this embodiment is issued a developer key signature, which is subsequently embedded in the program codes for the application. In this embodiment, block 810 further directs the microprocessor 202 to read the developer key signature in program codes for the application in the application storage location 244 of the memory 210 and to include the developer key signature in the call to the mesh port binding API function provided by the mesh service 310. Processing of the call to the mesh port binding API function by the 310 is described later herein with reference to block 1034-1040 in FIG. 10B.

The application event handling process 800 then continues at block 812, which directs the microprocessor 202 to determine whether the application has requested an encryption key exchange for secure transmission of data over the mesh network 100. If an encryption key exchange has been requested at block 812, the microprocessor 202 is directed to block 814 where a call is made to a mesh service API function that initiates the encryption key exchange. The mesh service 310 implements an API function called for exchanging cryptographic keys, which when called, transmits its cryptographic key to the target device having a specified uuid. When the device receives a cryptographic key it is stored in the local encryption key storage location 252 and the responds by transmitting its own cryptographic key back to the device that initiated the key exchange. When received by the initiating device, the cryptographic key is stored in the local encryption key storage location 252.

If an encryption key exchange has not been requested at block 812, the application event handling process 800 continues at block 816 which directs the microprocessor 202 to determine whether the associated application wishes to transmit data over the mesh network 100 via to the mesh service 310. As an example, for the chat application 302, the data may be a chat message including text and/or other content such as audio content, an image, or video content. Transmission of content data from the mesh applications 302 and 304 to the mesh service 310 is managed by the application interfaces 306 and 308. Block 816 directs the microprocessor 202 to call a mesh service function for transferring the content data to the mesh service 310. The call to the mesh service identifies the intended destination of the data (i.e. one or more of the devices 700 or 702 in FIG. 7) by including the uuid in the call.

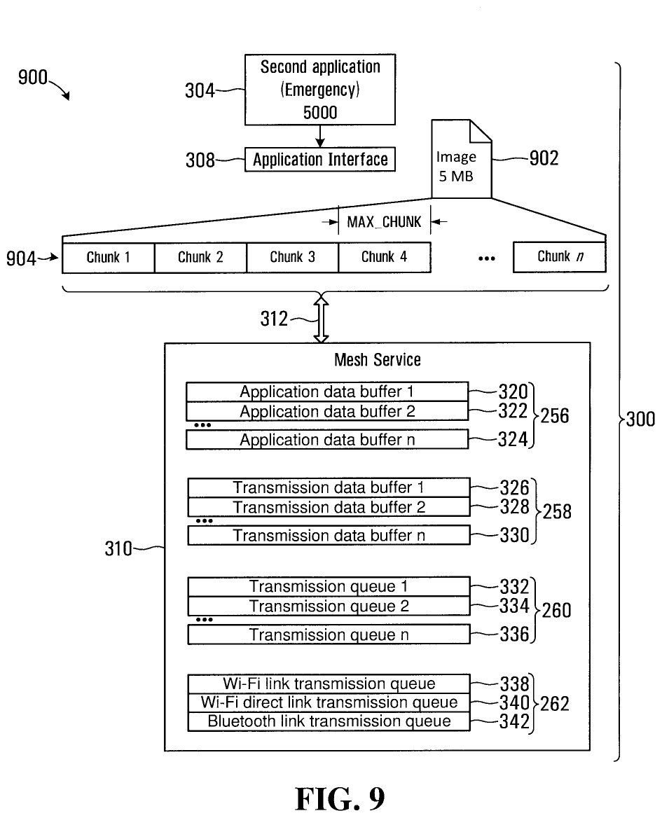

As noted above, for content data of a smaller size such as an image or chat message the messenger send/recv function may be used for the transmission to the mesh service 310. Block 818 directs the microprocessor 202 split the data into a plurality of data chunks for delivery to the mesh service 310 via the messenger send/recv function. An example of a content data transmission from the second application 304 on the device 300 is shown schematically in FIG. 9 at 900. Referring to FIG. 9 an image 902 of 5 Mbytes is shown to be split into n chunks shown at 904. In one embodiment the application interfaces 306 and 308 may implement a data chunk size limitation MAX_CHUNK that defines a maximum data size for the data chunks.

Referring back to FIG. 8, in this embodiment block 818 also directs the microprocessor 202 to write the overall data length of the image 902 as the first field of “Chunk 1”. The first “Chunk 1” thus serves to notify the mesh service 310 of the data length of the transfer and the remaining data chunks 2 to n will only include data. Block 818 then directs the microprocessor 202 to transmit the chunk 1 to the mesh service 310 using the messenger send/recv function.

Block 820 then directs the microprocessor 202 to determine whether the mesh service 310 is ready to receive the next chunk. When a call is received from an application 302 or 304 to transmit content data, the mesh service 310 allocates an application buffer 320 (shown in FIG. 9) for data flow. The application buffer 320 is held in the mesh service application buffer location 256 in memory 210. As described in more detail later herein, on receiving the chunk 1, the mesh service 310 determines whether there is room left in the applicable application buffer 320 for transmission of further data via the mesh network 100 and informs the applicable application interface 306 or 308 accordingly. If at block 820, the mesh service 310 is not yet ready to receive more data, block 820 directs the microprocessor 202 to repeat block 820.

If at block 820, the mesh service 310 is ready to receive more data the process continues at block 822 and the next chunk (chunk 2 in this case) is transmitted. Block 824 then directs the microprocessor 202 to determine whether further chunks remain to be transmitted, in which case the microprocessor is directed back to block 820. If at block 824, no further chunks remain to be transmitted, the microprocessor is directed back to 406 to await the next event.

If at block 816, there is no request from the application to transmit data over the mesh network 100, the process continues at block 826 in FIG. 8B. Referring to FIG. 8B, block 826 then directs the microprocessor 202 to determine whether the mesh service 310 has issued a peerChanged event. The peerChanged event is generated whenever the mesh service 310 detects that the status of one of the devices 102-112 on the mesh network 100 has changed.

If no peerChanged event is received at block 826, the application event handling process 800 continues at block 828 where the microprocessor 202 is directed to determine whether the mesh service 310 has issued a dataReceived event associated with one of the applications running on the device. For example, a dataReceived event is transmitted to the application interface 306 by the mesh service 310 when data associated with the mesh port 6000 is received over the mesh network 100.

If either a peerChanged event is received at block 826 or a dataReceived event is received at block 828 then the process continues at block 830, which causes the microprocessor 202 to process the event. Each application will generally process and display data and other events in accordance with configured behavior defined by the codes for the application stored in the storage location 244 of memory 210. For example, if the chat application 302 receives a peerChanged notification indicating that a user of one of the devices 102-112 has terminated the chat application, a display on the device 300 may be updated to remove the listing associated with that user or alternatively may indicate the user to be inactive. In the case where content data is received, the display of the device 300 may be updated to display a chat message or other content transmitted by another user of the mesh network 100. Block 830 then directs the microprocessor 202 back to block 406 of the process 400 to await the next event.

If at block 828, a dataReceived event is not received the process continues at block 832. As noted above, application developers may be required to go through a registration process before being permitted to provide applications for use on the mesh network 100. In one embodiment, additional functions may be exposed to registered application developers to enable setting of network roles of devices programmatically for testing and performance evaluation. The necessary functionality may be provided though a developer version of the codes for storage in the application storage location 244 of memory 210. In one embodiment the developer codes may limit devices from participating in a live mesh network 100, since an application could then be programmed to participate in the mesh network without sharing any of its own resources for establishing the network. Successful establishment of the mesh network 100 relies in the participation of devices in the mesh network to enable transmission of messages between other devices that are not within wireless communication range.

Block 832 is thus only accessible on devices running a version of the code provided to registered application developers having a valid developer key signature (as described above). Block 832 directs the microprocessor 202 to determine whether the associated application has requested state information for the mesh network 100. Such state information may include a listing of devices and network roles (routing mode, client mode, access point mode etc.), connectivity information related to specific devices, and other performance evaluation metrics. If at block 832, state information has been requested, block 834 directs the microprocessor 202 to request state information data from the mesh service 310. The state information data may be provided in the form of a structured data message including any or all of the above types of information. Block 834 then directs the microprocessor 202 back to block 406 of the process 400 to await the next event.

If at block 832 no request for state information is received, the process continues at block 836, which is also only accessible on devices running a version of the code provided to registered application developers having a valid developer key signature. Block 836 directs the microprocessor 202 to determine whether the associated application has requested access for setting specific mesh network communication parameters. For example, the application may wish to programmatically manipulate the network roles, wireless SSID, or Bluetooth identifiers for a number of devices involved establishing a test network. If such a request has been made by the application at block 836, then block 838 directs the microprocessor 202 to transmit a call to a mesh service function that provides such functionality. Block 838 then directs the microprocessor 202 back to block 406 of the process 400 to await the next event.

If at block 836 no request for setting specific mesh network communication parameters is received, the process continues at block 840. Block 840 directs the microprocessor 202 to determine whether the user of the application has requested display of the user preferences interface 500 shown in FIG. 5, in which case the microprocessor is directed to block 842. Block 842 directs the microprocessor 202 to cause the user preferences interface 500 to be displayed to receive user input, such as for example a change in the network role of the device on the mesh network 100. Block 844 then directs the microprocessor 202 to determine whether the user has changed any of the user preferences, in which case the process continues at block 846. Block 846 directs the microprocessor 202 to use the broadcast intents protocol to notify the mesh service 310 of the changed user preferences received at the user preferences interface 500. Block 846 then directs the microprocessor 202 back to block 406 of the process 400 to await the next event.

If at block 844, no user preferences are received the microprocessor 202 is directed to close the user preferences interface 500 and then directed back to block 406 of the process 400 to await the next event. If at block 840, the display of the user preferences interface 500 has not been requested then block 840 directs the microprocessor 202 back to block 406 of the process 400 to await the next event.

The application event handling process 800 thus directs the respective microprocessors of the devices 102-112 to implement necessary functionality for the application interfaces 306, 308, 700, and 712 to handle events originating from the respective applications and the mesh services 310, 708, and 714 running on each device as well as events originating at other devices that are forwarded to the application interfaces based on the mesh port identification.

A mesh service process executed by the processor circuit 200 for implementing mesh service functionality for the mesh service 310 (and mesh services 708 and 714) to handle events received at block 620 of the process 600 shown in FIG. 6 is shown in FIG. 10 at 1000. Referring to FIG. 10A, the mesh service process 1000 starts at block 1002, which directs the microprocessor 202 to determine whether a peerChanged event has been received from another device over the mesh network 100. If at block 1002, a peerChanged event has been received the process continues at block 1004, which directs the microprocessor 202 to determine the mesh port associated with the peerChanged event and to cause the application having a corresponding mesh port to be notified of the peerChanged event. For example, if a peerChanged event is received at the mesh service 310 from the device 702, the mesh port identifier will be 5000 and the peerChanged event will be transmitted to the application interface 308 of the second application 304. As disclosed above, the application interface 308 processes the peerChanged event in accordance with block 826 of the application event handling process 800 shown in FIG. 8. Block 1004 then directs the microprocessor 202 to return to block 620 of the process 600 to await further events.

If at block 1002, no peerChanged event is received then the microprocessor 202 is directed to block 1006 and directed to determine whether content data has been received from another device over the mesh network 100. If content data has been received at block 1006, the microprocessor 202 is directed to block 1008, which directs the microprocessor determine the mesh port associated with the content data. Block 1010 then directs the microprocessor 202 to determine whether an application corresponding to the determined mesh port is running on the device, in which case the process continues at block 1012. Block 1012 directs the microprocessor 202 to receive data over the mesh network 100 and deliver the data to the applicable application using one of the inter-process communication protocols disclosed above. In one embodiment the data may be written to a receive data buffer in the application buffer location 254 of memory 210. The receive data buffer is managed by the applicable application interface 306 or 308. Block 1012 also directs the microprocessor 202 to wait until the data transfer over the mesh network 100 is complete, and then notify the applicable application that the transmission is complete. The applicable application can then process the data in the receive data buffer of the application buffer location 254. In other embodiments, if the receive data buffer is filled by the data transfer prior to completion of the transmission, block 1012 may also direct the microprocessor 202 to notify the applicable application of a further amount of data still to be received. Large data transfers are thus prevented from overwhelming the application receive data buffer. Blocks 1006, 1008, 1010, and 1012, thus direct the microprocessor 202 to deliver the data to the application interface for the application corresponding to the mesh port. For example, if the content data is received from the second application 710 running on the device 702, the mesh port will be 5000 and the content data will be delivered to the application interface 308 associated with the second application 304. Block 1012 then directs the microprocessor 202 to return to block 620 of the process 600 to await further events.

If at block 1010, an application corresponding to the determined mesh port is not running on the device, then the microprocessor 202 is directed to block 1014, where the microprocessor is directed to forward the content over the mesh network 100 according to the routing protocol described later herein. Block 1014 then directs the microprocessor 202 to return to block 620 of the process 600 to await further events.

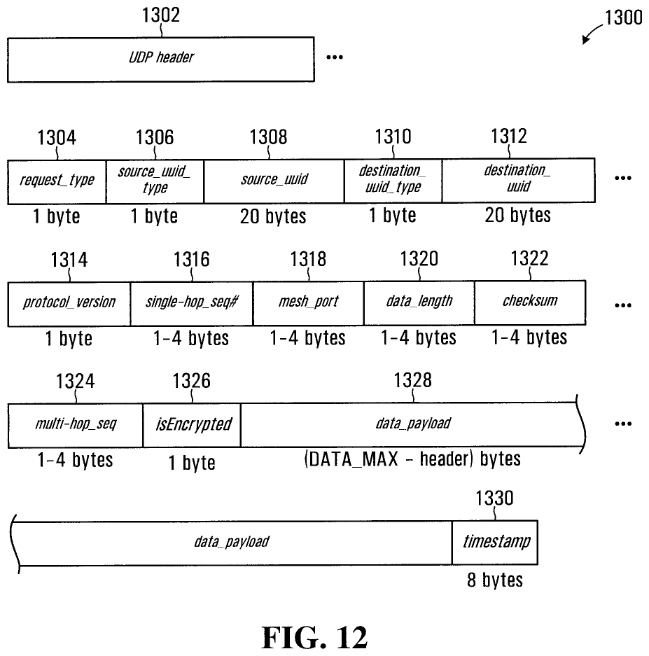

If at block 1006, no content data is received, the mesh service process 1000 continues at block 1016, which directs the microprocessor 202 to determine whether an encryption key exchange request has been received over the mesh network 100 from another device. If an encryption key exchange request has been received, block 1016 directs the microprocessor 202 to block 1018. The encryption key request may include a public key of the requesting device, in which case block 1018 directs the microprocessor 202 to add the public encryption key to the encryption key storage location 252 in the memory 210. Block 818 also directs the microprocessor 202 to transmit the device public encryption key over the mesh network 100 to the device that issued the encryption key exchange request. Finally block 818 directs the microprocessor 202 to notify the applicable application 302 or 304 that a device has requested encrypted communications. Encrypted communications rely on a cryptographic key exchange having been requested by an application at block 812 between the initiating device and a target device on the mesh network 100. Once the key exchange is completed and the key stored in the local encryption key storage location 252 the key may be used to encrypt data transmitted between the applications to an application on the target device that has a common mesh port. The data may be otherwise transmitted as described later herein except that the transmitted data has a byte value set to indicate that the data is encrypted (the isEncrypted field 1326 of the data packet 1300 is shown in FIG. 12. On the receiving side, the target device reads the isEncrypted field 1326, and looks for the associated encryption key in its local encryption key storage location 252. The encryption key, if found, is used to decrypt the data.

If at block 1016, an encryption key exchange request has not been received, the mesh service process 1000 continues at block 1020, which directs the microprocessor 202 to determine whether one of the applications 302 or 304 has changed the network role for the device 300 via the network role selector button controls 508 on the user preferences interface 500 shown in FIG. 5. If at block 1020 there no change in network role has been received, then the process continues at block 1022, which directs the microprocessor 202 to determine whether one of the applications 302 or 304 has disabled or enabled Wi-Fi or Bluetooth communications via the “Wi-Fi mesh” control 504 or “Bluetooth Mesh” control 506 on the user preferences interface 500.

For blocks 1020 and 1022, if there has been a change in either network role or communications settings, the process continues at block 1024, which directs the microprocessor to update the applicable mesh communication settings. The mesh communication settings determine how the mesh service 310 interacts with the mesh network 100, such as for example enabling of disabling wither Wi-Fi or Bluetooth capabilities of the wireless radio 216 shown in FIG. 2. The user of the device 300 thus has the ability to choose the network role and the use of the wireless radio 216. For example, if the device 300 has a low battery charge, the user may disable Wi-Fi communications to conserve battery power while still permitting Bluetooth communications to proceed. Block 1024 then directs the microprocessor 202 to return to block 620 of the process 600 to await further events.

If at block 1022, there is no change in communications settings, the process continues at block 1026. Block 1026 directs the microprocessor 202 to determine whether the application has disabled the mesh service 310 via the “Mesh Service” control 502 on the user preferences interface 500 in FIG. 5. If the mesh service 310 has been disabled, block 1026 directs the microprocessor 202 to block 1028 which directs the microprocessor to generate and transmit a peerChanged notification with the status of “removed” over the mesh network 100 so that other devices on the mesh network 100 can be updated that the device 300 will no longer be available on the network. Block 1028 further directs the microprocessor 202 to release all bound mesh ports (i.e. the ports 5000 and 6000) and to shut down the mesh service 310. Once the mesh service is shut down, the device 300 can no longer participate in the mesh network 100. In one embodiment the applications 302 and 304 may remain running in case the user decides to re-enable the mesh service 310. Alternatively, the applications 302 and 304 may be shut down at the same time as the mesh service 310. If at block 1026, the mesh service 310 has not been disabled, the mesh service process 1000 continues at block 1030 on FIG. 10B.

Referring to FIG. 10B, block 1030 is only implemented in the developer version of the codes as described above and directs the microprocessor 202 to determine whether either of the applications 302 or 304 has requested state information. The request for state information was previously described in connection with the block 832 of the application event handling process 800. If at block 1030 a request for state information has been issued by the either of the application interfaces 306 and 308 the process continues at block 1032, which directs the microprocessor 202 to transmit structured data defining the requested state information to the application interface. Block 1032 then directs the microprocessor 202 to return to block 620 of the process 600 to await further events.

If at block 1030, no request for state information has been received the process continues at block 1034, which directs the microprocessor 202 to determine whether a request to bind a mesh port has been received from one of the application interfaces 306 and 308. If a request to bind a mesh port has been received, the process continues at block 1036, which directs the microprocessor 202 to determine whether the developer key signature provided by the application interface 306 or 308 is authenticated for binding to the specific mesh port in the binding request. The mesh service 310 maintains a table of mesh ports assigned to various applications along with key signature data corresponding to the developer key signature. The table is maintained in the mesh port table location 250 of memory 210. If the developer key signature is authenticated at block 1036, then the application requesting the mesh port binding is permitted to bind to the requested mesh port and the mesh port table is updated to reflect the successful binding of the specific mesh port. As an example, the application 302 having been assigned the mesh port 6000 would only be permitted to bind to this mesh port if the mesh service 310 has a corresponding key signature indicating that the developer key signature is permitted to bind to this specific port (6000). The application 302 would not be permitted to bind to the mesh port 5000, even though the device 300 would be able to successfully bind the application 304 to the mesh port 5000. This has the advantage of separating traffic and preventing applications from maliciously listening in on data traffic intended for other applications. Block 1038 also directs the microprocessor 202 to transmit a notification to the application interface that originated the mesh port binding request and then directs the microprocessor to return to block 620 of the process 600 to await further events.

If the developer key signature is not authenticated at block 1036, block 1040 directs the microprocessor to transmit a notification to this effect to the application interface that originated the mesh port binding request and then directs the microprocessor to return to block 620 of the process 600 to await further events.

If at block 1034 a request to bind a mesh port has not been received, block 1042 directs the microprocessor 202 to determine whether a request to unbind a mesh port has been received. If a request to unbind a mesh port has been received, block 1042 directs the microprocessor 202 to release the bound mesh port and to update the mesh port table stored in the mesh port table location 250 of the memory 210. Block 1044 then directs the microprocessor 202 to return to block 620 of the process 600 to await further events.

If at block 1042, a request to unbind a mesh port has not been received then the mesh service process 1000 continues at block 1046. Block 1046 directs the microprocessor 202 to determine whether a content data chunk has been received for transmission by the mesh service 310 from one of the application interfaces 306 and 308 of the respective applications 302 and 304. If a content data chunk has been received, block 1046 directs the microprocessor 202 to assign an application data buffer in the mesh service application data buffer location 256 (i.e. the application buffer 320 shown in FIG. 9) for the data flow between the application and a destination identified by a uuid. Block 1046 also directs the microprocessor 202 to write the data to the application buffer 320.

As disclosed above, an application buffer is assigned for the specific application and for the specific destination on the mesh network 100 to which the application wishes to transmit the content. As such a unique application buffer would be allocated for the second application 304 on the device 300 transmitting data to the second application 710 on the device 702. If the second application 304 were also transmitting data to another device, a further application buffer would be allocated within the mesh service application buffer location 256. Each application buffer is thus associated with the originating application, the mesh port of the originating application, and the destination device. In other words, each application buffer is associated with a particular data flow from a source device (e.g. the device 300) to a destination device (e.g. the device 702) and is also associated with a particular mesh port.

Block 1046 then directs the microprocessor 202 to block 1048, which directs the microprocessor to determine whether further data chunks remain to be transmitted. As disclosed above in connection with block 818 of the application event handling process 800, the first data chunk includes a data length as a first field defining an overall length of the data transmission. If at block 1048 there is only a single data chunk for the transmission (i.e. the data length is less than the MAX_CHUNK parameter) then the microprocessor is directed to block 1050. Block 1050 directs the microprocessor 202 to add the data chunk to the application buffer 320 that is associated with the data flow. Block 1050 then directs the microprocessor 202 to return to block 620 of the process 600 to await further events.

If at block 1048 there is more than one data chunk for the transmission (i.e. the data length is greater than the MAX_CHUNK parameter) then the microprocessor is directed to block 1052. Block 1052 directs the microprocessor 202 to determine whether there is room in the application buffer 320 for the content data having the specific data length. Since the device 300 will generally have a limited memory size, the application buffers in the mesh service application buffer location 256 would need to be maintained at a reasonable size to avoid overloading the resources of the device. If the remaining room in the application buffer is less than twice the MAX_CHUNK parameter, then block 1052 directs the microprocessor 202 to block 1054 and the microprocessor is directed store the data chunk in the application buffer 320 and to notify the application interface that originated the content data transmission request that the mesh service 310 is not ready to receive more data chunks. Block 1050 then directs the microprocessor 202 to return to block 620 of the process 600 to await further events.

If at block 1052, the remaining room in the application buffer is more than twice the MAX_CHUNK parameter, the microprocessor 202 is directed to block 1056 where the microprocessor is directed store the data chunk in the application buffer 320 and to notify the application interface that originated the content data transmission request that the mesh service 310 is ready to receive more data chunks. Block 1056 then directs the microprocessor 202 to return to block 620 of the process 600 to await further events. Blocks 1046-1056 are thus repeated as each data chunk is received at the mesh service 310 from the application interface 306 or 308 of the applications 302 and 304.

As disclosed above in connection with FIG. 8, blocks 818 to 824 of the application event handling process 800 direct the microprocessor 202 to manage how quickly the data is pushed from the applications 302 and 304 to the mesh service 310 for transmission over the mesh network 100. Blocks 1054 and 1056 of the mesh service process 1000 provide signals to the application interfaces 306 and 308 to control the transmission rate of data chunks from the application interfaces 306 and 308 to the mesh service.

Referring back to FIG. 9, as disclosed above, the image 902 is thus split into n data chunks as shown at 904 by the application interface 308 of the second application 304. The messenger send/recv inter-process communication protocol 312 is used to transmit the chunks 904 between the application interface 308 and the mesh service 310 as described above in connection with blocks 816-824 of the application event handling process 800 and blocks 1046-1056 of the mesh service process 1000. These blocks thus work in concert to transfer content data between the application 304 and the mesh service 310 and prevent the mesh service from being flooded with data for transmission over the mesh network 100.

The mesh service 310 thus accumulates data for transmission over the mesh network 100 in a plurality of application and destination specific data buffers in the mesh service application buffer location 256 of memory 210. The data is received in data chunks, but is stored in the application buffer as a contiguous series of data bytes. At block 1046 of the mesh service process 1000, when content data chunks for transmission have been received from the applicable application and written to one of the application buffers 256 in the mesh service application buffer location 256 for the particular data flow, the mesh service 310 then processes the data for transmission.

### Reliable Data Transmission

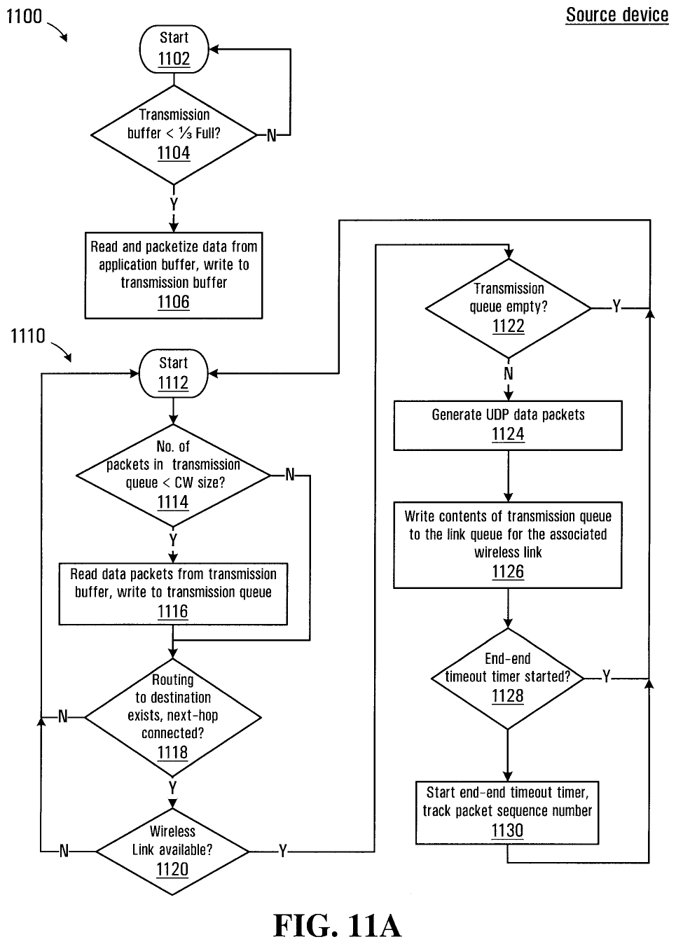

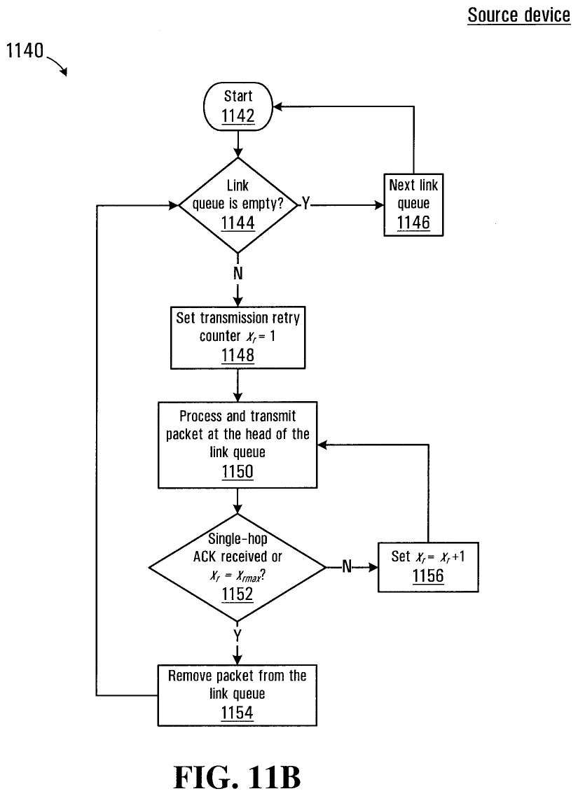

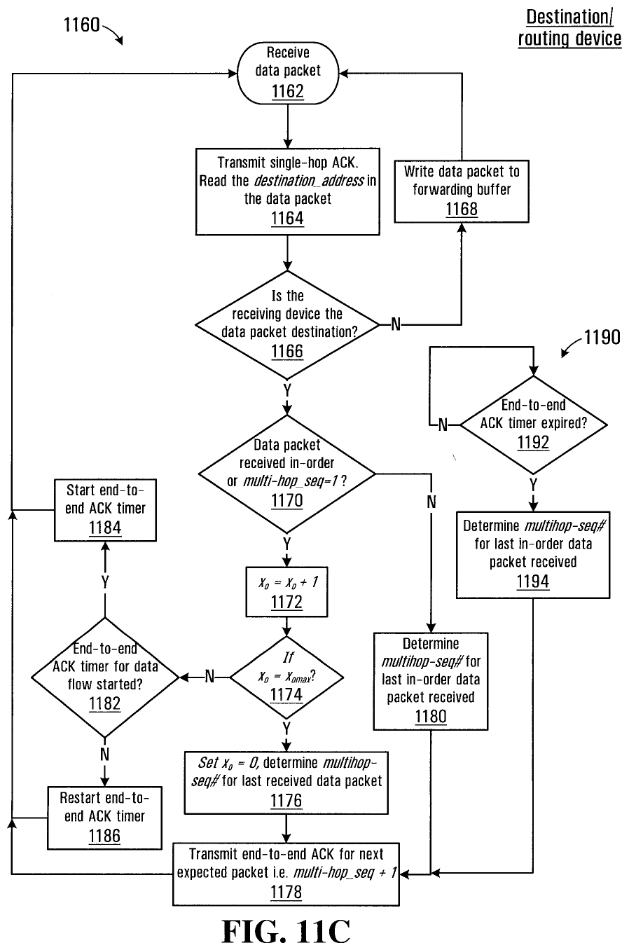

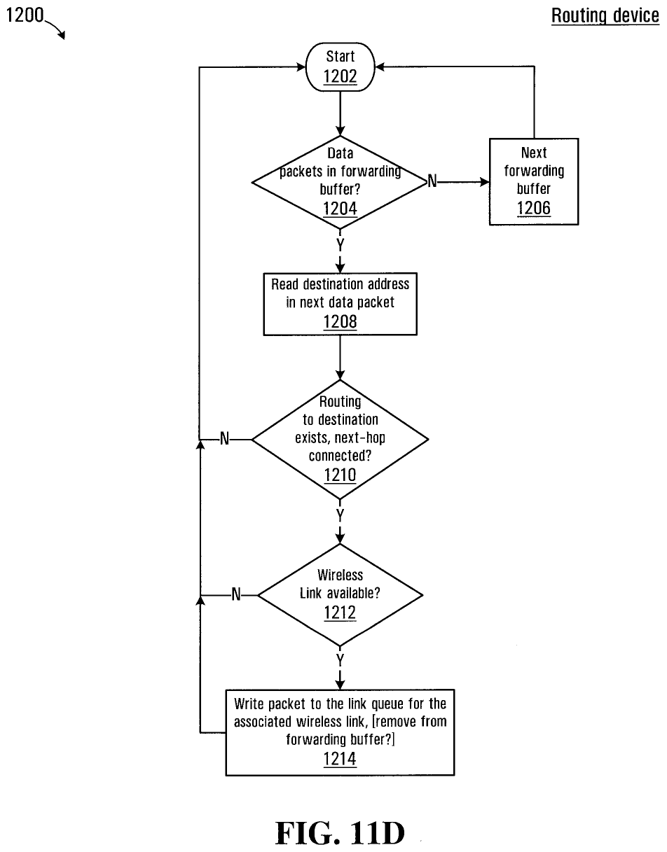

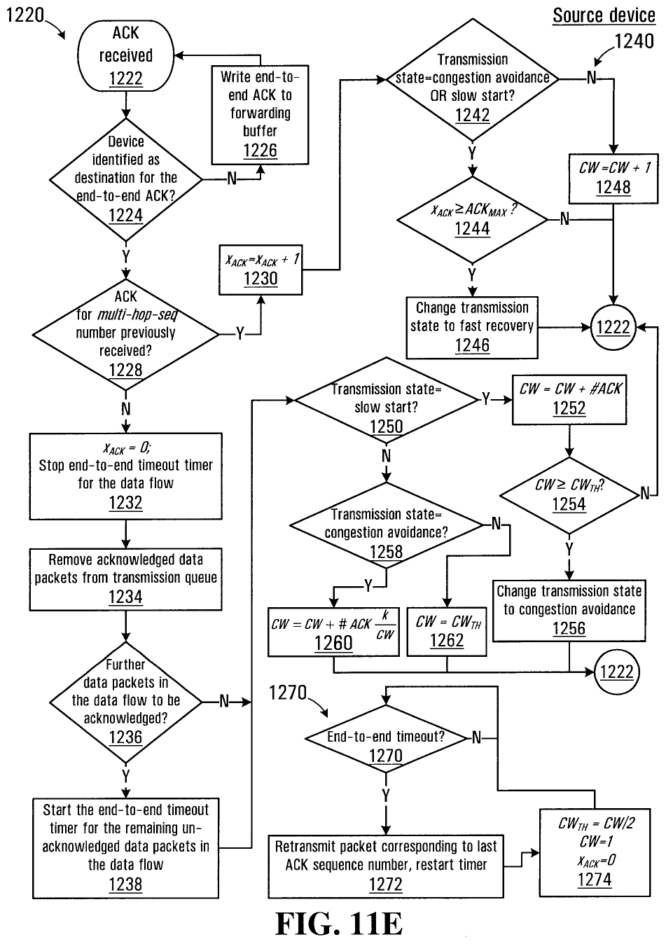

A reliable data transmission process embodiment is shown in FIG. 11. The reliable data transmission process involves at least a source device (such as the device 300 shown in FIG. 7) and a destination device (such as the device 702), and may further involve one or more routing devices (such as the device 700). Reliable data transmission generally involves the monitoring of data flows over the mesh network 100 by the source device 300 to confirm that the data has been received by the destination device 702. In other embodiments, unreliable transmission protocols may also be used in some cases, as described later herein. The reliable data transmission process is generally used for unicast data (i.e. data transmitted from the source device 300 to a single destination device 702).

### Source Device Transmission

The mesh service 310 allocates a transmission data buffer (shown at 326, 328, or 330 in FIG. 9) in mesh service transmission data buffer location 258 for each allocated application buffer 320, 322, and 324. As such, a transmission buffer is allocated for each data flow from an application to a destination device that is associated with a specific mesh port. There may be more than one data flow between the source device 300 and a destination device. For example if the mesh network 100 shown in FIG. 7 were to include another device on which instances of the first and second applications 302 and 304 were both running, the mesh service 310 of the device 300 would allocate a first application buffer for a data flow between the application 302 and the destination and a second application buffer for the data flow between the application 304 and the destination. These first and second application buffers would have the same source uuid and destination uuid, but would have different mesh ports (i.e. 6000 an 5000).

Referring to FIG. 11A, the reliable data transmission process includes a process thread 1100 that is run for each data flow (i.e. for each application buffer 256 on a device such as the device 300) and starts at 1102. Block 1104 directs the microprocessor 202 of the source device 300 to determine whether the allocated corresponding transmission buffer (i.e. the transmission buffer 326) for the data flow is less than one-third full. If at block 1104, the transmission buffer 326 is more than one-third full, the microprocessor 202 is directed back to the start of the thread 1100. If at block 1104, the transmission buffer 326 is less than one-third full the microprocessor 202 is directed to block 1106, which directs the microprocessor to read and packetize data from the application buffer 320 and write the data into the transmission buffer 326. In one embodiment the mesh service 310 encodes data for transmission over the mesh network 100 in data packets that are configured to facilitate transmission over the mesh network 100. The data packets may generally conform to User Datagram Protocol (UDP), although at this time the destination is only identifiable through the uuid of the destination device, since the network address of the destination device on the mesh network 100 will only be resolved when the mesh service 310 attempts to route the data packets over the network, as described later herein. In general, the size of the data packets written into the transmission buffer 326 will be as large as possible within the constraints of the maximum transmission unit (MTU) that can be transmitted by the various wireless links implemented by the wireless radio 216 of the device. In one embodiment the transmission buffer 326 may be sized to hold about 300 data packets, and thus block 1106 is executed whenever there are determined to be less than 100 data packets in the transmission buffer. The thread 1100 may be repeated at a time interval commensurate with a data transmission rate over the mesh network 100.

In this embodiment Transmission Control Protocol (TCP) is not used for data transmission over the mesh network 100 since the mesh network 100 relies on a variety of differing addresses to be accommodated whereas TCP only natively supports Internet Protocol (IP) addressing. TCP is also a connection based protocol, and since devices making up the mesh network 100 that are configured in routing mode periodically switch between being connected to different devices in master mode, each switch would interrupt the TCP connection and would require additional overhead to re-establish. Further, TCP does not support multi-path routes unless a modified version of TCP is used which is not supported under the Android operating system.

Still referring to FIG. 11A, the reliable data transmission process also includes a process thread 1110 that is run for each data flow and starts at 1112. For each data flow, the mesh service 310 allocates a transmission queue (332, 334, or 336) corresponding to the respective application buffers 326, 328, and 330. The transmission queues 332, 334, and 336 are stored in the mesh service transmission queue location 260 in memory 210. In this embodiment the process 1110 uses the transmission queues in conjunction with a variable congestion window to provide functionality for avoiding transmission congestion on the mesh network 100. If each device (300, 700, 702) on the mesh network 100 were to transmit data as fast as possible, severe congestion may result rendering the mesh network 100 inoperable. A size of the congestion window determines the maximum number of data packets that will be transmitted over the mesh network 100, before the transmitting device is able to confirm that the transmitted packets have been received by the destination device. In one embodiment the congestion window size is initially set to 1 (i.e. a single data packet is transmitted) and is subsequently increased based on successful confirmation of receipt of the transmitted packet by the destination as described later herein.

The process 1110 is executed for each particular data flow and begins at block 1112. Block 1114 directs the microprocessor 202 of the source device 300 to determine whether a number of data packets in the transmission queue (for example the transmission queue 332) for the data flow is less than the current congestion window (CW) size. As an example, if the transmission has just commenced for the data flow associated with the transmission queue 332 then the transmission queue will be empty and block 1114 directs the microprocessor 202 to block 1116. Block 1116 directs the microprocessor 202 to read a number of data packets corresponding to the congestion window size from the transmission buffer 326 and to add the data packets to the transmission queue 332. Block 1116 also directs the microprocessor 202 to remove the data packets from the transmission buffer 326. As disclosed above, initially the congestion window queue size may be set to 1, and thus a single data packet may be added to the transmission queue 332. If at block 1114, the number of data packets in the transmission queue 332 for the data flow is not less than the current congestion window (CW) size, the microprocessor 202 is directed to block 1118.

The process 1110 then continues at block 1118 which directs the microprocessor 202 to determine whether routing information to the destination device exists. The mesh service 310 maintains a routing table in the routing table location 264 of memory 210 as generally described in U.S. provisional patent application 62/343,056 as referenced above and which is incorporated herein by reference in its entirety. The routing table lists previously discovered destination devices on the mesh network 100 by their mesh network address.

Each device has at least one role in the mesh network 100, which could be as a client, a routing device, and an access point. The client transmits a “hello” message to an access point device to request an association to the access point. The access point device may transmit an acknowledgement (“Hello ACK”) granting the association request. The client may connect via WiFi, WiFi, or Bluetooth depending on the wireless protocols currently supported by the access point device. The topology of the mesh networks for routing is constructed with the clusters centered at master peers and connected into mesh with the dual roles on masters or via the routers. We have the basic signaling packets been introduced in the previous pattern for the routing establishment purpose.

Each destination device has an associated next-hop address, which if the destination device is in direct connection with the transmitting device will be the address of the destination device and a hop counter would thus be set to 1. In cases where the destination device is not in direct communication, but rather connected via one or more other routing devices on the mesh network 100, the next-hop address will be the address of the routing device. If the destination was only separated by one routing device the hop counter would be set to 2. A next-hop counter of 3 or more indicates that there are two or more routing devices between the transmitting device and the destination device. The transmitting device is thus only concerned with the next-hop device and sees the remaining mesh network 100 behind the next-hop device as a black box with only the addresses of the devices on the mesh network 100 and the applicable hop counts available. In one embodiment, if there are more than one next-hop devices leading to the destination device and more than one packet is being transmitted, the packets may be transmitted over different paths simultaneously to reduce network latency.

Block 1118 of the process 1110 thus directs the microprocessor 202 to determine whether the destination device is listed in the routing table 264 and additionally directs the microprocessor 202 to determine whether the next-hop is currently connected. As noted above, devices in routing mode alternate between connecting to different access points and thus although appearing in the routing table 264 as a potential next-hop device, may be currently unavailable to route data. If at block 1118 either the destination device is not listed in the routing table 264 or the next-hop in the routing table is currently disconnected, the microprocessor 202 is directed back to block 1112. If at block 1118 the destination device is listed in the routing table 264 and is currently connected, the microprocessor 202 is directed to block 1120.

Block 1120 directs the microprocessor 202 to determine whether the wireless link (i.e. Wi-Fi, Wi-Fi direct, or Bluetooth) associated with the wireless radio 216 is available for transmissions, in which case the process continues at block 1122. Block 1122 directs the microprocessor 202 to determine whether the transmission queue 332 is empty, in which case the microprocessor is directed back to block 1112 and blocks 11114-1120 are repeated until there is data in the transmission queue to transmit. If at block 1122 the transmission queue 332 is not empty, then the microprocessor 202 is directed to block 1124.

As disclosed above the wireless radio 216 of each device may provide for connections via several different wireless links or protocols, such as Wi-Fi, Wi-Fi Direct, Bluetooth etc. The mesh service 310 allocates a link queue for each wireless link. The link queues are held within the wireless link queue location 262 of memory 210. For example, the mesh service 310 may allocate and maintain a Wi-Fi queue 338, a Wi-Fi direct queue 340, and a Bluetooth queue 342. As disclosed above, on some devices one or more of the wireless links may be temporarily or permanently unavailable and as such queues would only be allocated for the available wireless links.

Block 1124 then directs the microprocessor 202 to generate data packets for transmission. An example of a data packet is shown in FIG. 12 at 1300. Referring to FIG. 12, the data packet 1300 has an overall size of MAX_SIZE and includes a plurality of data fields depicted as sequential blocks. When the data packet 1300 is to be transmitted as a UDP data packet, the packet starts with a UDP header 1302. The UDP header is used for Wi-Fi and Wi-Fi direct transmissions but not for Bluetooth transmissions which follows a different protocol.

The data packet 1300 starts with a 1 byte request type field 1304 indicating whether the transmission is a reliable or unreliable transmission. The data packet 1300 also includes a source_uuid_type field 1306 and source_uuid field 1308. The source_uuid field 1308 is used to hold the address (of source_uuid_type) for the device making the request. Similarly, the data packet 1300 also includes a destination_uuid_type field 1310 and a destination_uuid field 1312, where the destination_uuid field is used to hold a uuid of destination_uuid_type for the device to which the request is being transmitted. In one embodiment the request_type field 1304, source_uuid_type field 1306, and destination_uuid_type field 1310 may be stored as 1 byte enumerations using the Varint data type provided in the Android operating system. The source_uuid field 1308 and destination_uuid field 1312 in this embodiment occupy 20 bytes of the data packet 1300. The data packet 1300 also includes a protocol_version field 1314 that holds a 1 byte value indicating a protocol version that may be used, for example, to provide compatibility with later revisions to the UDP protocol.

When transmitting via Bluetooth protocol, the UDP header 1302 is not used. Rather an integer with the number of bytes to come is transmitted. The receiving Bluetooth device reads data bytes until the specified number of bytes are received. When the data packet is forwarded via Bluetooth the appropriate Bluetooth wireless link is selected and the data is enqueued in the correct queue based on a destination MAC address from the routing table. For internet protocol transmissions over the Wi-Fi and Wi-Fi direct links, the destination address is appended when the data packet is enqueued in a single hop queue.

The data packet 1300 also includes a single-hop_seq # field 1316 for tracking a series of data packets transmitted by a wireless link over the mesh network 100 through a single-hop. When generating UDP data packets 1300 at the level of the wireless link at block 1124, a sequential single-hop_seq # value is written to the field 1316 to permit identification of which data packets are successfully transmitted as described below. The data packet 1300 also includes a mesh port field 1318 for holding the mesh port identifier for the application generating the request, as described above. These fields are each encoded using the Varint data type, which serializes integers using between one and four bytes and where smaller numbers take a smaller number of bytes for efficiency of communications.

The data packet 1300 also includes a number of fields related to a payload to be carried in the data packet, including a data_length field 1320 that holds a value specifying the byte length of the data payload. In this embodiment only the first data packet in a sequence of data packets will include the data_length field 1320. An optional checksum field 1322 may be included for verifying the integrity of the data communication via the mesh network 100. The data packet 1300 also includes a multi-hop_seq field 1324, which identifies the order of each data packet in a sequence of transmitted data packets. Unique consecutive integers may be used for the multi-hop_seq field 1324. In one embodiment the multi-hop_seq may reuse sequences of numbers in a cyclic manner without ambiguity as long as the maximum possible sequence number is large enough.

A data_payload field 1328 has a size of DATA_MAX less the number of header bytes in the remaining fields of the data packet. In this embodiment the data packet 1300 also includes an isEncrypted field 1326 for holding an indication of whether the data payload in the data packet 1300 has been encrypted.

The data packet 1300 also includes a timestamp field 1330 for holding a transmission time associated with the data packet. While the timestamp field 1330 is shown as part of the data packet shown in FIG. 12, the timestamp is not transmitted to other devices but rather only held in data packets enqueued for transmission on the device.

Block 1124 also directs the microprocessor 202 to write the current time into the timestamp field 1330 of the data packet 1300 (although as disclosed above this timestamp is not transmitted over the mesh network 100 but rather used by the source device for tracking purposes as described later herein). The process thread 1110 then continues at block 1126, which directs the microprocessor 202 to write the contents (i.e. a data packet or data packets) of the link queue 332 to an applicable wireless link queue (for example the Wi-Fi queue 338).

Block 1128 then directs the microprocessor 202 to determine whether an end-to-end timeout timer has been started for the data flow. The end-to-end timeout timer would have been started if earlier transmitted data packets in the data flow have already been written to the queue 338 for transmission by the Wi-Fi link. In this case block 1128 directs the microprocessor 202 back to block 1112. If the end-to-end timeout timer has not yet been started then the data packets written to the queue 338 are the first data packets in the data flow and the microprocessor 202 is directed to block 1130, where the end-to-end timeout timer is started. Block 1130 then directs the microprocessor 202 back to block 1112 and the thread 1110 is repeated for further data packets in the data flow.

Referring to FIG. 11B, the reliable data transmission process also includes a single-hop transmission process thread 1140 which starts at 1142. The single-hop transmission process thread 1140 directs the wireless radio 216 to operate on each link queue 338, 340, and 342 and transmit the data packets for the data flow. Block 1144 directs the microprocessor 202 of the source device 300 to determine whether the link queue (for example the Wi-Fi queue 338) is empty, in which case the microprocessor is directed at block 1146 to process the next link queue and the process then resumes at 1142. If at block 1144 the link queue is not empty, the microprocessor 202 is directed to block 1148, where a transmission retry counter xᵣ is initialized to the value 1. The transmission retry counter is held in the counter location 266 in the memory 210 and is used to monitor transmission attempts for transmission of a particular data packet by the wireless link.

Block 1150 then directs the microprocessor 202 to process the data packet at the head of the link queue 338 for transmission. Each wireless link will have a specific transmission protocol and transmission format and the wireless link will perform the necessary encapsulation of the data packet 1300 within its own particular transmission format. For example, Wi-Fi and Wi-Fi direct links that transit data using the internet protocol (IP) encapsulate the data packets 1300 along with the UDP header 1302 shown in FIG. 12. In some embodiments the data packet 1300 may be larger than can be transmitted by the wireless link, which may have to break the data packet up for transmission into smaller data packets. If the data packet is shown in FIG. 12 at 1300 are broken up, the single-hop_seq # field 1316 is used for a single-hop acknowledgement to ensure the data packets makes it to the next hop to also ensure the packets arrive at the destination. The wireless link operates on the single-hop queue to transmit all of the packets it can and each single-hop packet has a time associated with the transmission. If there is a timeout before receiving a single-hop ACK, the transmitting device will resend the data until it reaches a MAX_RETRIES set for the wireless link, at which point the packet is dropped. The wireless link sets and maintains the single-hop_seq # 1316.

Block 1150 then directs the microprocessor 202 to cause the wireless radio 216 to transmit the data packet over the wireless link (in this case the Wi-Fi wireless link) to the next-hop device. The single-hop transmission process thread 1140 then continues at block 1152, which directs the microprocessor 202 to monitor whether a single-hop acknowledgement (single-hop ACK) is received back from the next-hop device within a period of time. The period of time is implemented as a pre-determined maximum time, but the transmitting device waits for a randomized time up to the maximum time before retransmitting. The randomized time is used to reduce the chance of failing to link with a device in router mode that periodically disconnects from one access point device to connect to another access point device. Following each retransmission, a longer wait time is allowed to expire before dropping the packed when the MAX_RETRIES threshold is reached.

The single-hop ACK includes the single-hop_seq # read from the filed 1316 of the received data packet and provides the transmitting device with confirmation that the identified data packet has reached its intended destination. Block 1152 also directs the microprocessor 202 to determine whether the transmission retry counter xᵣ has reached a maximum retry threshold rₘₐₓ. In one embodiment the value of rₘₐₓ is set to 3 corresponding to three retry attempts for each data packet transmission. If at block 1152, the single-hop ACK is received or the transmission retry counter xᵣ has reached the maximum retry threshold rₘₐₓ, the single-hop transmission process thread 1140 continues at block 1154 which directs the microprocessor 202 to remove the data packet from the link queue 338. As such, when the transmission by the wireless link is not successful, the data packet is removed from the queue and no further attempts are made for transmission. The reliable transmission process thus falls back on an end-to-end acknowledgement process as described later herein. One advantage of the single-hop acknowledgement process is that spurious transmission failures are prevented through the limited retry mechanism without causing the process to endlessly attempt retransmission via a disrupted single-hop link. When transmitting data packets over multiple hops across the mesh network 100, it is fairly likely that there would be a transmission failure at one of the hops. The single-hop transmission process thread 1140 thus permits the mesh network 100 to recover from the failure by attempting retransmission thus reducing the number of end-to-end retransmissions, which are described in more detail below. Block 1154 then directs the microprocessor 202 back to block 1144 and blocks 1144-1156 are repeated as described above.

The nexthop uuid is determined when the routing to a destination device is found. Depending on whether the wireless linek is a Wi-Fi link or a Bluetooth link, the MAC address or IP address may be needed for the nexthop. If it is a MAC address, the Bluetooth link implementation will have determined MAC addresses of all of the 1:1 Bluetooth links and the data packets are enqueued in the correct Bluetooth link queue. For IP transmissions over Wi-Fi or Wi-Fi direct wireless links, the next-hop IP address is added to the UDP data packets based on a lookup of the next-hop device in the routing table location 264. This IP address is filled into the UDP header 1302 for the transmission to the nexthop device. The destination_uuid field 1312 in the data packet thus identifies the end destination device for the data packet 1300, while the next-hop IP addresses on the mesh network 100 identify the next device to which the data packet will be transmitted to eventually reach the destination device.

If at block 1152, the single-hop ACK is not yet received and the transmission retry counter xᵣ has not yet reached the maximum retry threshold rₘₐₓ, the microprocessor 202 is directed to block 1156 where the transmission retry counter xᵣ is incremented. Block 1156 then directs the microprocessor 202 back to block 1150 and a further attempt is made to transmit the data packet over the wireless link.

The single-hop process thread 1140 is implemented for each wireless link queue and on each device in the mesh network 100 such that data propagates through the mesh network 100 over successive single-hop transmissions to the intended destination.

### Destination/Routing

Referring to FIG. 11C, the reliable data transmission process also includes an end-to-end acknowledgement process thread 1160 that is implemented by the mesh service on receiving devices on the mesh network 100. The end-to-end acknowledgement process thread 1160 starts at 1162 when a data packet is received at any device on the mesh network 100. Block 1164 directs the microprocessor 202 of the receiving device (i.e. either a routing device or the destination device 702) to transmit a single-hop ACK back to the device that transmitted the data packet acknowledging that the data packet has been received. As described above in connection with block 1152 of the single-hop transmission process thread 1140, the single-hop ACK is used by the source device 300 (or other routing device if there are multiple hops across the mesh network 100 for the transmission) to manage the wireless link queues 262 at each device.

Block 1164 then directs the microprocessor 202 to read the destination_uuid field 1312 of the data packet and block 1166 directs the microprocessor to determine whether the receiving device is the end destination of the data packet by comparing the contents of the destination_uuid field with the device's own address on the mesh network 100. If the device is not the end destination for the data packet, but rather is acting as a routing device, the process thread continues at block 1168 where the microprocessor 202 is directed to write the data packet to a forwarding buffer 268 in the memory 210. A thread for directing a routing device to manage the forwarding buffer 268 is described later herein with reference to FIG. 11D. The process 1160 then continues at block 1168, which directs the microprocessor 202 back to 1162 to await receipt of the next data packet over the wireless link. Accordingly, if the device is acting as a routing device for the data flow only blocks 1162-1168 of the process 11160 will be executed when forwarding a data packet.

If at block 1166 the receiving device is the end destination for the data packet (i.e. the destination_uuid field 1312 matches the device's own address on the mesh network 100) then the microprocessor 202 is directed to block 1170. Block 1170 directs the microprocessor 202 to determine whether the received data packet is an in-order data packet associated with an ongoing data flow by reading the multi-hop_seq field 1324. Each data packet received at the device may be determined to be associated with a particular data flow based on the source_uuid field 1308, the destination_uuid field 1312, and the mesh_port field 1318. If one or more data packets associated with an ongoing data flow has already been received by the device, the next data packet will be expected to have a multi-hop_seq field 1324 that is incremented by 1 over the last received packet for the data flow. At block 1170 the microprocessor 202 is thus directed to determine whether the received data packet matches the next expected multi-hop_seq for an in-progress data flow or is the first packet in a data flow (multi-hop_seq=1). In either case the process continues at block 1172, which directs the microprocessor 202 to increment a threshold counter x₀. The threshold counter x₀ is stored in the counter location 266 of the memory 210 and is used to maintain a count of sequentially received in-order data packets. Block 1174 then directs the microprocessor 202 to determine whether the threshold counter x₀ has reached a threshold value x₀ₘₐₓ.

The process thread 1160 then continues at block 1176 where the microprocessor 202 is directed to reset the threshold counter x₀ to 0. Block 1176 also directs the microprocessor 202 to determine the sequence number of the last in-order data packet received in the data flow. Block 1178 then directs the microprocessor 202 to generate and transmit an end-to-end ACK back to device identified as the source of the data flow by the source_uuid field 1308 in the data packets. The end-to-end ACK includes the sequence number of the next expected data packet determined by incrementing the sequence number of the last received in-order data packet. In this embodiment, the end-to-end ACK rather than identifying the last packet successfully received, identifies the next expected data packet by sequence number. In other embodiments the end-to-end ACK could identify the last packet successfully received. Block 1178 then directs the microprocessor 202 back to block 1162 to await receipt of further data packets.

The threshold value X₀ₘₐₓ would typically be set to a value of at least 2 or 3 to cause the end-to-end ACK to only be transmitted over the mesh network 100 after more than one data packet associated with a data flow has been received. The end-to-end acknowledgement process thread 1160 thus avoids flooding the mesh network 100 with end-to-end ACK messages by only generating the ACK messages to acknowledge receipt of several data packets rather than for each single packet.

If at block 1174 the threshold counter x₀ has not yet reached a threshold value X₀ₘₐₓ, the process continues at block 1182, which directs the microprocessor 202 to determine whether an end-to-end acknowledgement timer (ACK timer) has been started for the data flow. If the data packet was the first packet in a data flow, then the end-to-end ACK timer will not have been started, and at block 1184 a timer is associated with the data flow and initialized to zero. If at block 1182 an end-to-end ACK timer was previously stared, the microprocessor 202 is directed to block 1186 and the end-to-end ACK timer is reset to zero. The end-to-end ACK timer is used in conjunction with an end-to-end ACK timer expiry threshold to establish a time period during which the device will wait to receive more data packets associated with a data flow.

In a separate thread 1190 related to the end-to-end acknowledgement process thread 1160, block 1192 monitors the end-to-end ACK timer and if the timer reaches the expiry threshold, the microprocessor 202 of the receiving device is directed to block 1194. Block 1194 then directs the microprocessor 202 to determine the value from the multi-hop_seq field 1324 of the last in-order data packet received. Block 1194 also directs the microprocessor 202 to block 1178, where an end-to-end ACK identifying the next expected data packet is transmitted over the mesh network 100 back to the source device. The end-to-end acknowledgement process thread 1160 thus further implements a timeout within which time the number of data packets set by the value of x₀ₘₐₓ must be received. If the timeout is reached, the destination device no longer waits for further data packets and transmits an end-to-end ACK back to the source device identifying the next expected packet.

If at block 1170 an out of order data packet is received, the microprocessor 202 is directed to block 1180 where the microprocessor is directed to determine the value of the multi-hop_seq field 1324 in the last received in-order data packet. Block 1180 then directs the microprocessor 202 to block 1178, where the microprocessor is directed to transmit an end-to-end ACK for the next expected packet in the data flow (i.e. multi-hop_seq+1). This has the effect of notifying the source device of the multi-hop_seq of first packet of one or more missing data packets in the data flow so that the data packets can be retransmitted.

As disclosed above, when at block 1168 the data packet is determined to have a destination other than the receiving device, then the device acts as a routing device (for example the device 700 in FIG. 3) and writes the data packet to its forwarding buffer 268. Referring to FIG. 11D, a forwarding process thread run on the routing device 700 for processing the forwarding buffer 268 is shown at 1200 and starts at 1202. The forwarding process thread 1200 runs on each of the forwarding buffers 268 on the device. Block 1204 directs the microprocessor 202 of the routing device to determine whether there are any data packets in the forwarding buffer 268. If there are no packets in the forwarding buffer 268, the microprocessor 202 is directed to block 1206, which directs the microprocessor to process the next forwarding buffer in the location 268.

If at block 1204, there are one or more data packets in the forwarding buffer then the microprocessor 202 is directed to block 1208, which directs the microprocessor to read the destination_uuid field 1312 in the data packet. The forwarding process thread 1200 then continues at block 1210, which directs the microprocessor 202 to determine whether routing information to the destination device exists by determining whether the destination device is listed in the device routing table 264. Block 1210 additionally directs the microprocessor 202 to determine whether the next-hop is currently connected. If at block 1210 the destination device is listed in the routing table 264 and is currently connected, the microprocessor 202 is directed to block 1212.

Block 1212 directs the microprocessor 202 to determine whether the wireless link interface associated with the wireless radio 216 is available, in which case the process continues at block 1214. Block 1214 directs the microprocessor 202 to write the data packet to the link queue for the wireless link selected for the transmission. Block 1214 also directs the microprocessor 202 to remove the data packet from the forwarding buffer. Transmission of the forwarded data packet is in accordance with the single-hop transmission process thread 1140 shown in FIG. 11B, and the wireless link will make several (rₘₐₓ) attempts to forward the data packet. If the forwarding transmission fails, the packet is removed from the link queue and further processing for reliable transmission reverts back to the source device as described later herein.

Referring back to FIG. 11C, at block 1178 the end-to-end acknowledgement process thread 1160 of the reliable data transmission process transmits an end-to-end ACK identifying the next expected packet in a data flow. In this embodiment the end-to-end ACK conforms to the format of the UDP data packet 1300 but has an empty data payload field and includes the sequence number of the next expected data packet for the flow in the multi-hop_seq field 1324. The end-to-end ACK is transmitted over the mesh network 100 via one or more single-hop transmissions as described above although the destination device does not implement the end-to-end acknowledgement process for ACK data packets as described above.

### Source Acknowledgement Processing

Referring to FIG. 11E, the reliable data transmission process also includes a source acknowledgement processing thread 1220 that is run for each data flow and starts at 1222 when an end-to-end ACK is received. Block 1224 directs the microprocessor 202 of the source device 300 to read the destination_uuid field 1312 in the end-to-end ACK and to determine whether the ACK is addressed to the source device. If the end-to-end ACK is addressed to another device on the mesh network 100, block 1226 directs the microprocessor 202 to write the end-to-end ACK to the forwarding buffer 268. The forwarding process thread 1200 will then forward the ACK along over the mesh network 100.

If at block 1224 the end-to-end ACK is addressed to the source device, the microprocessor 202 is directed to block 1228. Block 1228 directs the microprocessor 202 to determine whether the ACK sequence number in the multi-hop_seq field 1324 of the ACK data packet has been previously received. If the source device has previously received an ACK indicating the same next-expected data packet, then the process continues at block 1230, which directs the microprocessor 202 to increment a counter x_{ACC} used to count the number of times the same end-to-end ACK has been received. Receipt of the same end-to-end ACK sequence number several times indicates that a link over the mesh network to the destination may no longer be available since data packet is not reaching the destination device. Block 1230 then directs the microprocessor 202 to block 1242.

If at block 1228 the source device has not previously received an ACK indicating the same next-expected data packet, then the end-to-end ACK confirms that all previous data packets in the data flow have been received and block 1232 directs the microprocessor 202 to reset the counter x_{ACC} to zero. Block 1232 also directs the microprocessor 202 to stop the end-to-end timeout counter associated with the data flow, which as disclosed above was started at block 1130 of the process thread 1110.

Block 1234 then directs the microprocessor 202 to remove the data packets for which receipt has been acknowledged from the transmission queue 332. Referring back to FIG. 11A, at block 1126 data packets from the allocated transmission queue 258 are written to the selected link queue 338, 340, or 342, but are not removed from the transmission queue until block 1234 directs the microprocessor 202 to remove the data packets after processing the end-to-end ACK. There may thus be several data packets held in sequential order at the head of the transmission queue 332, for which acknowledgement is pending. As described in connection with the end-to-end acknowledgement process thread 1160, an end-to-end ACK may not be transmitted for every data packet received at the destination device 702, but rather is transmitted when x₀ₘₐₓ in-order packets have been received or the end-to-end ACK timer expires. The end-to-end ACK received at the source may thus have a sequence number in the multi-hop_seq field 1324 that corresponds to a data packet that is being held either at the head of the transmission queue 332 or a few packets in from the head of the transmission queue. In either case block 1234 of the source acknowledgement processing thread 1220 will direct the microprocessor 202 to remove the all data packets from the transmission queue 332 having a sequence number less than the sequence number in the end-to-end ACK.

Following execution of block 1234, if a data packet corresponding to the sequence number in the received end-to-end ACK exists (i.e. the next data packet pending acknowledgement), then the data packet moves to the head of the applicable transmission queue 260 followed by remaining data packets (if these exist).

Block 1236 then directs the microprocessor 202 to determine whether there are further data packets in the data flow yet to be acknowledged by the destination device by determining whether further packets remain in the transmission queue 332. If at block 1236 at least one a data packet pending acknowledgement remains the transmission queue 332, then block 124 directs the microprocessor 202 to block 1238. Block 1238 directs the microprocessor 202 to read the timestamp field 1330 from the data packet and to reset the end-to-end timeout timer based on the timestamp value. The end-to-end timeout is thus updated based on the actual time of transmission of the next data packet pending acknowledgement. Block 1238 then directs the microprocessor 202 to block 1250. If at block 1236, there are no remaining data packets in the applicable transmission queue 260 to be transmitted, the microprocessor 202 is also directed to block 1250.

### Transmission Congestion

At blocks 1230, 1236, and 1238 of the source acknowledgement processing thread 1220, having processed the end-to-end ACK the microprocessor 202 is then directed to execute a network congestion process thread 1240. The network congestion process thread 1240 monitors congestion experienced by the data flow over the mesh network 100 and adapts transmissions from the source device 300 accordingly. At block 1250, the microprocessor 202 is directed to determine a transmission state of the mesh network 100. In this embodiment three possible transmission states for data flows across the mesh network 100 are implemented at the source device. A slow start transmission state is implemented when initiating a data flow at the source device 300. Under the slow start transmission state, the reliable transmission process starts out with a congestion window size CW=1 (data packet). A congestion avoidance state and a fast recovery state are also implemented as described below. Block 1250 directs the microprocessor 202 to determine whether the current transmission state is set to slow start, in which case the microprocessor is directed block 1252. Block 1252 directs the microprocessor 202 to increment the congestion window CW by the number of data packets (i.e. # ACK) acknowledged in the received end-to-end ACK from the destination device. This modest increase prevents the source device 300 from transmitting a large number of data packets before there is an opportunity to determine whether the mesh network 100 is traffic congested or not. The congestion window is maintained within the transmission queue 332 as described above in connection with the process thread 1110 and sufficient storage within the mesh service transmission queue location 260 is allocated to permit the size of the congestion window to be increased if the mesh network 100 is uncongested.

The process thread 1240 then continues at block 1254, where the microprocessor 202 is directed to determine whether the current size of the congestion window CW is greater than a congestion window threshold size CW_{TH}. The congestion window threshold size CW_{TH} may be changed during the reliable data transmission process but will be maintained at or above a pre-defined minimum size. If at block 1254, the size of the congestion window CW remains below CW_{TH}, the microprocessor 202 is directed back to block 1222 to await the next end-to-end ACK.

If the congestion window size has reached CW_{TH} at block 1254, then the microprocessor 202 is directed to block 1256 where the transmission state is set to congestion avoidance. The microprocessor 202 is then directed back to block 1222 to await the next end-to-end ACK. The reliable transmission process thus commences transmission at a conservative rate and will increase the transmission rate by increasing the size of the congestion window up to a threshold CW_{TH}.

If at block 1250, the transmission state is not set to slow start the microprocessor 202 is directed to block 1258 where the microprocessor is directed to determine whether the transmission state is set to congestion avoidance. If the transmission state is set to congestion avoidance, block 1258 directs the microprocessor 202 to block 1260. At block 1260 the microprocessor 202 is directed to increment the size of the congestion window CW by a fraction k/CW for each acknowledged data packet, where k may have an integer value of =1, 2, 3 etc. The term k/CW will generally equate to a decimal value and will result in a much slower increase in the size of the congestion window CW. Since the congestion window size is expressed as an integer number of data packets, the size of the congestion window will only increase when successive fractional increments add up to cause another data packet to be added to the congestion window size. Under the congestion avoidance state the congestion window thus only increases in size at a slow rate. The microprocessor 202 is then directed back to block 1222 to await the next end-to-end ACK.

If at block 1258 the transmission state is not set to congestion avoidance the current transmission state is fast recovery and the microprocessor 202 is directed to block 1262 where the congestion window is set to the congestion window threshold size CW_{TH}. The microprocessor 202 is then directed back to block 1222 to await the next end-to-end ACK. Blocks 1250-1256 thus increment the size of the congestion window when there is a successful acknowledgement of data packets being received at the destination device 70, which indicates that the mesh network 100 has end-to-end transmission links established and is not yet traffic congested.

At block 1228 when more than one end-to-end ACK having an identical sequence number are received at the source device 300, the X_{ACK} counter is incremented as described above and the microprocessor 202 is directed to block 1242 of the network congestion process thread 1240. Block 1242 directs the microprocessor 202 to determine whether the current transmission state is either slow start or congestion avoidance, in which case the process continues at block 1244. Block 1244 directs the microprocessor to determine whether the x_{ACK} counter has reached the ACK_{MAX} threshold (which in one embodiment may be set to 3). Block 1246 then directs the microprocessor 202 to set the transmission state to fast recovery. When in the slow start or congestion avoidance transmission state, the source device 300 thus waits before retransmitting the data packets expected by the destination device 702. If at block 1242 the X_{ACK} counter has not yet reached the ACK_{MAX} threshold, the microprocessor 202 is directed to block 1222 to await the next end-to-end ACK.

If at block 1242, the microprocessor 202 determines that the transmission state is already set to fast recovery then the microprocessor is directed to block 1248 where the size of the congestion window CW is incremented by a single data packet. In this case, it is assumed that while there are some data packets for which transmission has failed, generally data packets are still reaching the destination devices and this a modest increase to the congestion window should not be problematic.

The source device 300 also runs a retransmission process thread 1270 for monitoring the end-to-end timer to determine whether a timeout has occurred for the data packet currently at the head of the transmission queue 332. If at block 1272 the timestamp field 1330 in the data packet exceeds a pre-determined threshold time, then the microprocessor 202 is directed to block 1272 where the data packet corresponding to the end-to-end ACK sequence number is retransmitted. The end-to-end timeout timer is also restarted based on the time of the retransmission and the timestamp field 1330 in the data packet is updated accordingly.

Block 1274 then directs the microprocessor 202 to reset the size of the congestion window CW to a single data packet. The congestion window threshold size CW_{TH} is also set to half of the current size of the congestion window and the X_{ACK} counter is reset to zero since the expected packet in the end-to-end ACK has been retransmitted.

### Transmission Priority

Referring back to FIG. 11B, in one embodiment priority transmission may be implemented in the single-hop transmission process thread 1140. At block 1150, rather than simply processing the data packets from the head of the link queue 338, the microprocessor 202 may be directed to prioritize transmission of certain types of data packets. When a large amount of content data is being transmitted over a congested mesh network 100, the content data is handled in normal transmission sequence may cause end-to-end ACK and single-hop ACK packets to be delayed. Delay of these acknowledgement data packets may result in retransmission of data packets by the source device when the packets have actually been received at the destination and acknowledged in an end-to-end ACK or retransmission attempts by wireless links when the single-hop ACK is delayed. Other control messages (HELLO, JOIN, LEAVE etc.) as described in above-referenced U.S. provisional patent application 62/343,056, incorporated herein by reference in its entirety, relate to establishment of the mesh network 100 and delay of these messages prevent efficient expansion of the network, thus further increasing congestion. In one embodiment, block 1150 may direct the microprocessor 202 to process data packets in each wireless link queue 262 in a priority order. For example, a highest priority may be assigned to acknowledgement of control packets and the next priority to the control packets themselves. A lower priority may be assigned to end-to-end and single-hop ACK data packets. A lowest priority may be assigned to content data packets. In this alternative embodiment, block 1150 thus directs the microprocessor 202 to empty the link transmission queues according to the assigned priority. In other embodiments different types of content data flows could be assigned different priorities.

### Multicast Transmission

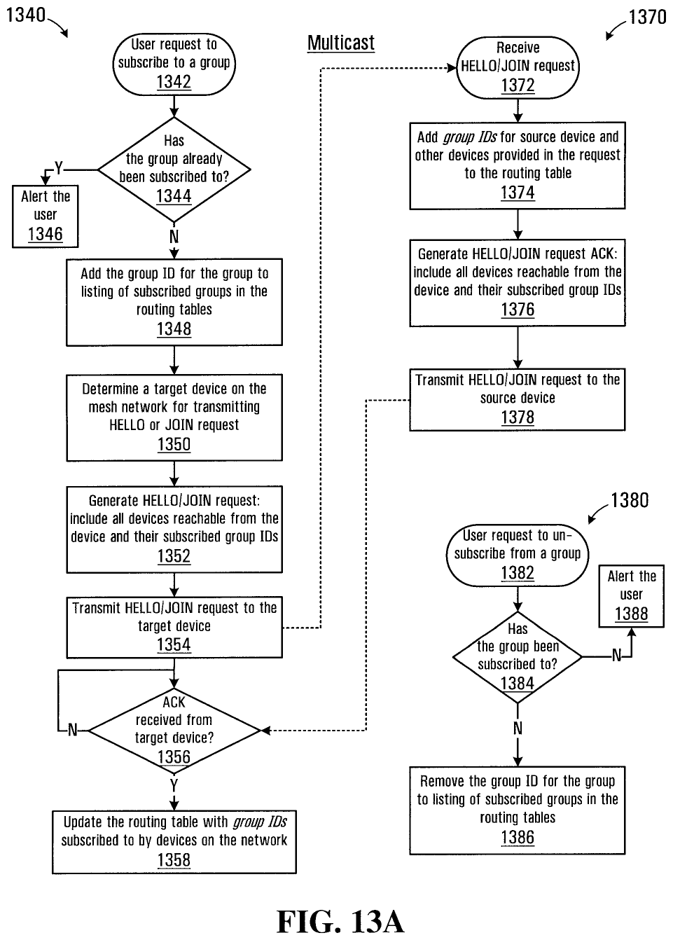

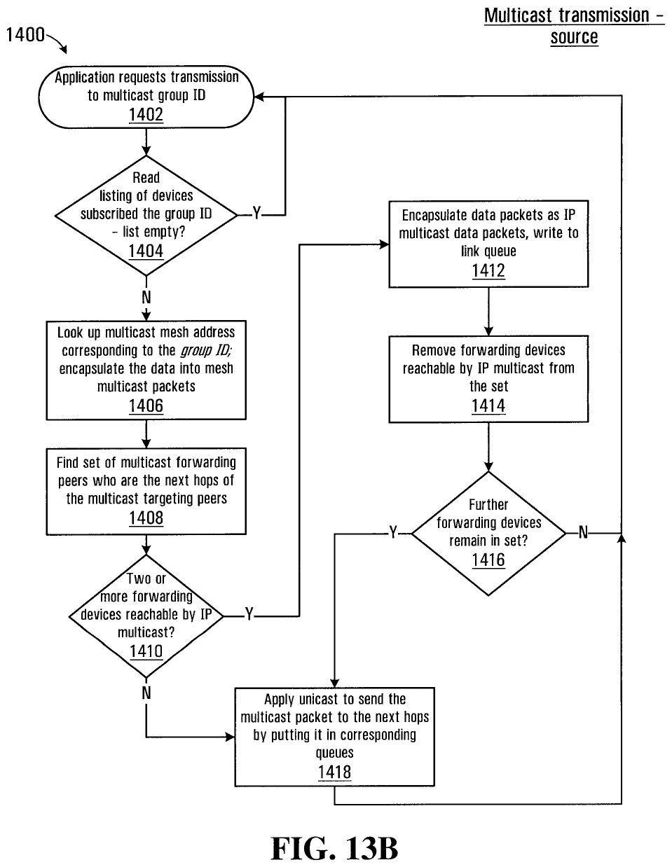

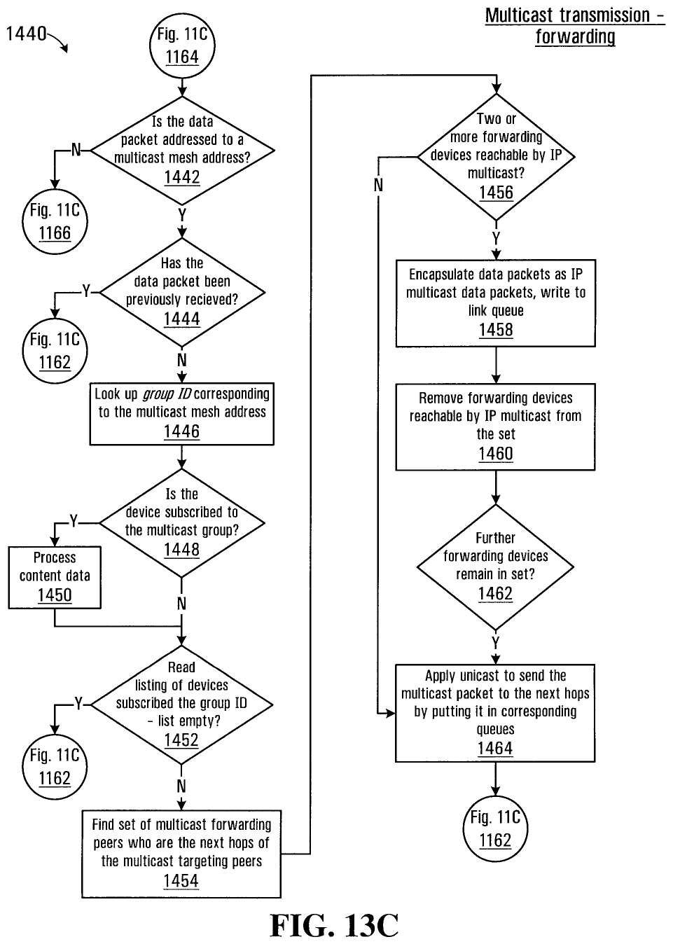

A multicast data transmission process embodiment is shown in FIG. 13. The multicast data transmission process involves a transmission from a source device (such as the device 300 in FIG. 7) to multiple destination devices, and may further involve one or more routing devices (such as the device 700).

Referring to FIG. 13A, a subscription process executed by a device for subscribing to a multicast group is shown at 1340 and starts at block 1342 when a user of the device initiates a request to join a multicast group. In one embodiment the multicast group may be associated with one of the applications 302, 304, 704, and 710 and the request from the user to join the multicast group may be received within the application and transmitted to the mesh service 310 as a call to an API that handles subscription requests. Each group is identified by a group ID Block 1344 then directs the microprocessor 202 of the source device to determine whether the group has already been subscribed to. As devices are discovered on the mesh network 100 these are added to the routing table location 264 and groupID's that these devices are subscribed to are associated with the device in the in the routing table. If the group has already been subscribed to then there would be at least one entry in the routing table location 264 for a device having a group ID matching the group ID that the user wishes to subscribe to. If there is already a matching group ID in the routing table location 264 then the microprocessor is directed to block 1346 where the microprocessor is directed to issue an alert to the user that the group has been previously subscribed to.

If at block 1344 there is net yet a matching group ID in the routing table location 264 then the microprocessor is directed to block 1348. Block 1348 directs the microprocessor 202 to add the group ID to the list of multicast groups that are subscribed to on the device. Block 1350 then directs the microprocessor 202 to determine a target device on the mesh network 100 to which a request will be sent to receive a listing of devices on the mesh network that are also subscribed to the multicast group. The target device would typically be device on the mesh network 100 separated from the source device by a single hop over the network, such as an access point device in master mode to which the source device is connected.

Block 1352 then directs the microprocessor 202 to generate a request including a listing of devices along with applicable group IDs. The listing should include the source device and subscribed group IDs, and a listing of other devices that are reachable over the mesh network 100 by the source device, but not via the target device. The request may take the form of a HELLO or JOIN request (generally as described above) with the addition of the subscribed group IDs for each device. Block 1354 then directs the microprocessor 202 to transmit the request to the target device. The process 1340 then continues at block 1356, which directs the microprocessor 202 of the source device 300 to determine whether an acknowledgement (ACK) has been received from the target device. If no ACK has been received then the microprocessor 202 is directed back to block 1356 and the process 1340 is effectively suspended awaiting the ACK.

A subscription response process executed by the target device is shown at 1370 and is initiated at block 1372 when a request is received at the target device from another device on the mesh network 100. Block 1374 directs the microprocessor 202 of the target device to read the listing in the request message and to update the routing table location 264 to add the group IDs for the source device and other devices included in the request message. The target device thus updates its routing tables in the routing table location 264 each time a request message is received.

Block 1378 then directs the microprocessor 202 to generate a listing of devices that are reachable from the target device along with their respective subscribed group IDs. The source device that originated the request would be excluded from the listing. Block 1376 also directs the microprocessor 202 to generate an acknowledgement (HELLO/JOIN ACK) that includes the listing of reachable devices. The process 1370 then continues at block 1378, which directs the microprocessor 202 of the target device to transmit the acknowledgement back to the source device that originated the request.

The process 1340 continues at block 1356 when the ACK is received from the target device and the microprocessor 202 of the source device is directed to block 1358. Block 1358 directs the microprocessor 202 to update the routing table in the routing table location 264 on the source device to include the group IDs identifying multicast groups subscribed to by devices on the mesh network 100.

An unsubscribe process executed on devices such as the source device 300 is also shown in FIG. 13 at 1380. The unsubscribe process 1380 is initiated when a user of the source device 300 makes a request to unsubscribe from a multicast group. Block 1384 then directs the microprocessor 202 of the source device to determine whether the group is being subscribed to, in which case block 1386 directs the microprocessor to remove the multicast group from the listing of group IDs subscribed to by the device. If there is no matching group ID in the routing table location 264 then the microprocessor 202 is directed to block 1348 where the microprocessor is directed to issue an alert to the user that the group is not currently being subscribed to.

In contrast to conventional multicast groups which are maintained by server or router infrastructure used to construct the network, the mesh network 100 does not necessarily have a central repository for multicast group information. Multicast group information must thus be disseminated and shared across the mesh network 100 in accordance with the multicast data transmission process shown in FIG. 13.

A multicast transmission process is shown in FIG. 13B at 1400, and starts at block 1402 when one of the applications 302, 304, 704, and 710 requests transmission of content data to a multicast group corresponding to a specific group ID. The transmission of the content data between the application and the mesh service 310 generally proceeds in accordance with blocks 816-824 of the application event handling process 800 shown in FIG. 4, except that rather than identifying the destination for the content data by a uuid the destination is identified by a group ID. The group ID may be a number having a distinctive format that is identifiable by the mesh service 310 as being associated with e multicast group transmission. The content data is received by the mesh service 310 and processed in accordance with blocks 1046-1056 of the mesh service process 1000 shown in FIG. 10A.

Block 1404 directs the microprocessor 202 to read the listing of devices and associated group id's in the routing table location 264 of memory 210 to determine which devices on the mesh network 100 are subscribed to the multicast group corresponding to the group ID. These devices will be referred to as the multicast target devices. Block 1404 also directs the microprocessor 202 to determine whether the list is empty (i.e. no multicast target devices remain connected to the device), in which case the microprocessor is directed back to block 1402 to await the next request for a multicast transmission.

Block 1406 then directs the microprocessor 202 to look up a multicast mesh address corresponding to the group ID. In this embodiment a group of addresses on the mesh network 100 are not assigned to any physical device on the network and are only used for multicast mesh transmissions. The multicast mesh addresses may thus have a specific address pattern and may be allocated from a range of network addresses reserved for multicast group transmissions. Block 1406 also directs the microprocessor 202 to write the data into a data packet for transmission over the mesh network 100. The data packet may generally correspond to the UDP data packet 1300 shown in FIG. 13, where the address of the transmitting device is written to the source_uuid field 1308 and the multicast mesh address is written to the destination_uuid field 1312.

The multicast transmission process 1400 then continues at block 1408, where the microprocessor 202 is directed to determine a next-hop for each of the multicast target devices identified at block 1404. Each multicast target device should have a next-hop entry in the routing table location 264 either identifying a forwarding device on the network through which the multicast target device can be reached or if the a multicast target device is the next-hop, identifying the device itself. The forwarding device may not be a multicast target device and may thus only be involved in forwarding the multicast packets to the multicast target device. In some cases there may be multiple devices that are identified as forwarding devices to the multicast target devices. Block 1408 thus directs the microprocessor 202 to generate a set of next-hop devices that are able to act as the multicast forwarding devices for the multicast transmission to the multicast target devices.

Block 1410 then directs the microprocessor 202 to determine whether there are two or more forwarding devices in the set of multicast forwarding devices that are reachable by internet protocol (IP) multicast forwarding. Since the next-hop forwarding device for each multicast target device are neighboring devices to the source device, the routing table will contain entries identifying the applicable wireless link or links available for the transmission. If the transmitting device is a Wi-Fi or Wi-Fi direct device in access point or master mode and if at block 1410, the microprocessor 202 determines that there are two or more Wi-Fi or Wi-Fi direct client mode forwarding devices accessible over the mesh network 100, then the process continues at block 1412. Under these conditions, the two or more client mode forwarding devices will be reachable through IP multicast forwarding of the data packets.

Block 1412 then directs the microprocessor 202 to encapsulate the data packets into IP multicast packets. The IP multicast packets are then written to the applicable que 338 or 340 in the wireless link queue location 262, and transmission continues generally as described at blocks 1142-1154 of the single-hop transmission process thread 1140 shown in FIG. 11B except that the data packets are transmitted as IP multicast protocol packets. However, multicast transmissions may not implement any form of end-to-end acknowledgement, since this would lead to additional congestion on the mesh network 100. Rather multicast transmissions may follow a best effort transmission.

Block 1414 then directs the microprocessor 202 to remove the devices that are reachable by internet protocol (IP) multicast forwarding from the set of multicast forwarding devices, since the transmission to these devices is considered to have been completed. Block 1414 then directs the microprocessor 202 back to block 1416, which directs the microprocessor 202 to determine whether any multicast forwarding devices remain in the set. If no multicast forwarding devices remain in the set, block 1416 directs the microprocessor 202 back to block 1402 to await the next multicast transmission.

If at block 1416, further devices remain in the multicast forwarding device set, these will only be accessible by unicast transmission, and the microprocessor is directed to block 1418. Block 1418 directs the microprocessor 202 to perform a unicast transmission of the data packets for the remaining multicast forwarding devices in the set. The data packets are thus written to the link queues (i.e. Bluetooth link queue 342) in the wireless link queue location 262 and the transmission proceeds in accordance with the process single-hop transmission process thread 1140 shown in FIG. 11B. Block 1418 then directs the microprocessor 202 back to block 1402 to await the next multicast transmission.

If at block 1410 either a single or forwarding device or no forwarding devices in the set of multicast forwarding devices that are reachable by internet protocol (IP) multicast forwarding, then the microprocessor is directed to block 1418 where the microprocessor 202 is directed to perform a unicast transmission of the data packets for the remaining multicast forwarding devices.

Transmission of data packets to multicast groups on the mesh network 100 is thus performed in accordance with the most efficient protocol available at the source device. The use of IP multicast protocol simplifies the processing for wireless links that support this protocol.

A multicast forwarding process is shown in FIG. 13C at 1440, and may insert between blocks 1164 and 1166 of the end-to-end acknowledgement process thread 1160 shown in FIG. 11C. The process thus begins at block 1162 (FIG. 11C) when a data packet is received at any device on the mesh network 100.

Block 1164 directs the microprocessor 202 of the receiving device to transmit a single-hop ACK back to the device that transmitted the data packet acknowledging that the data packet has been received, as described above. Block 1164 also directs the microprocessor 202 to read the destination_uuid field 1312 of the data packet.

Block 1442 of the multicast forwarding process 1440 then directs the microprocessor 202 to determine whether the address in the destination_uuid field 1312 of the data packet corresponds to a range of addresses reserved for multicast transmissions over the mesh network 100. If the address in the data packet is not a multicast address, then block 1142 directs the microprocessor 202 back to block 1166 of the end-to-end acknowledgement process thread 1160 and unicast processing of the data packet proceeds as described above. If the address in the data packet is a multicast address, then block 1142 directs the microprocessor 202 to block 1144, which directs the microprocessor to determine whether the specific multicast data packet has been previously received. For multicast transmissions, there is a possibility that the same data packet may be received from two different multicast forwarding devices, and in this case block 1144 directs the microprocessor 202 back to block 1162 of the end-to-end acknowledgement process thread 1160 to await receipt of the next data packet.

If at block 1444, the multicast data packet has not previously been received at the multicast forwarding device, the process continues at block 1446. Block 1446 directs the microprocessor 202 to use the multicast mesh address to look up the corresponding group ID in the routing table location 264. Block 1448 then directs the microprocessor 202 to determine whether the device is subscribed to the multicast group corresponding to the group ID determined at block 1446. If the device is subscribed to the multicast group, block 1148 directs the microprocessor 202 to block 1448 to process the content data and deliver the data to the applicable application generally in accordance with blocks 1006-1012 of the mesh service process 1000 shown in FIG. 10A.

If at block 1448, the device is not subscribed to the multicast group, the microprocessor 202 is directed to block 1452. Blocks 1452-1464 are identical to blocks 1404 and 1408-1418 of the multicast transmission process 1400 shown in FIG. 13B and cause the multicast data packets to be further propagated over the mesh network 100 to multicast target devices. Following execution of block 1464, the microprocessor 202 is directed back to block 1162 of the end-to-end acknowledgement process thread 1160 to await receipt of the next data packet.

The multicast forwarding process 1440 thus causes multicast data packets to be delivered to the device if subscribed to the multicast group associated with a multicast mesh address. The multicast forwarding process 1440 also causes multicast data packets to be forwarded on to next-hop devices if there are any entries found in the listing of subscribed devices at block 1452. If the device is the last multicast target device on a particular branch of the mesh network 100 then no forwarding is necessary. The multicast process shown in FIG. 13 thus facilitates propagation of data content to multiple devices while avoiding unnecessary transmission of data packets. Apart from implementing the single-hop transmission process thread 1140 for the wireless link transmissions between neighboring devices, the process is conducted on an unreliable data transfer basis.

### Broadcast Transmissions

A broadcast transmission is similar to a multicast transmission except that all devices on the mesh network 100 are considered to be broadcast target devices. Broadcast transmission data packets are also targeted to a single broadcast mesh address rather than one in a range of reserved multicast addresses. In one embodiment that address may be set up with all bits of the address set to “1”. To avoid flooding the mesh network 100 with circulating broadcast data packets, the packet data packet 1300 shown in FIG. 12 may be adapted to include a time-to-live (TTL) field. When the TTL time is reached, there is thus no further forwarding of the data packets by devices. Since all devices on the mesh network 100 are “subscribed” to the broadcast, the processes 1340 and 1370 shown in FIG. 13A are not relevant and are thus omitted for broadcast traffic. The processes 1400 and 1440 are modified so that rather than determining forwarding devices based on the group ID as in the case of multicast transmissions, all known devices are considered as forwarding devices. The source device thus finds all the known devices and looks in the routing table location 264 for the next hops leading to all these devices. The transmission to these forwarding devices proceeds in a similar manner to blocks 1410-1418 of the process 1400 shown in FIG. 13B.

Each broadcast forwarding device determines whether the broadcast data packet has been previously received and if not, processes the data content for delivery to associated applications on the device and for forwarding over the mesh network 100 to other broadcast target devices. A broadcast transmission may be identified by a broadcast flow ID including a source address and a mesh port id. As in the case of the reliable data transmission process shown in FIG. 11, unique sequence numbers may be used to identify the order of data packets in the broadcast transmission. Devices may track the last received sequence number for each broadcast transmission to determine whether data packets are received in duplicate and to avoid duplicated forwarding of the same data packet.

While specific embodiments have been described and illustrated, such embodiments should be considered illustrative of the invention only and not as limiting the invention as construed in accordance with the accompanying claims.

What is claimed is:

1. A method for communicating over a mesh network established between a plurality of devices, each device having a wireless radio, the method comprising:
launching a mesh service on each device, the mesh service being operable to cause a processor circuit of the device to provide functionality for controlling the wireless radio for communication between devices over the mesh network;
wherein each device has at least one application running on the device, the at least one application being associated with a mesh port, the mesh port being used to designate data transmissions as being associated with instances of a specific application running on at least some of the devices in the plurality of devices, the at least one application and the mesh service on each device being in data communication;
in response to a specific application running on a device requesting the mesh service to provide access to the mesh network for communication via a specific mesh port:
causing the mesh service to determine whether the specific application is authorized for communications on the specific mesh port;
if the specific application is authorized, processing requests from the application to communicate on the specific mesh port over the mesh network and forwarding data transmissions associated with the specific mesh port to the specific application; and
if the specific application is not authorized, declining requests from the application to communicate on the specific mesh port over the mesh network and preventing access by the specific application to data transmissions associated with the specific mesh port.

2. The method of claim 1 wherein launching the mesh service comprises launching the mesh service when booting an operating system on the device.

3. The method of claim 1 wherein launching the mesh service comprises:
in response to the specific application being launched on a device, determining whether the mesh service is currently running on the device; and
if the mesh service is not currently running, launching the mesh service on the device.

4. The method of claim 3 further comprising, if the mesh service is currently running on the device, determining whether a mesh service version is current, and if not terminating the running mesh service and re-launching an updated mesh service.

5. The method of claim 4 further comprising:
receiving program codes for updating the mesh service; and
prior to updating the mesh service, reading a cryptographic code within the program codes and determining whether the cryptographic code accords with a cryptographic code previously stored on the device.

5. The method of claim 3 wherein the mesh service is launched by causing the processor circuit of the device to execute a mesh service set of computer readable instructions included within an application set of computer readable instructions that are executed by the processor circuit for launching the specific application.

6. The method of claim 1 wherein an operating system run by the processor circuit of each device is operably configured to provide separated functionality for running services on the device, and wherein the method involves running the mesh service using the separated functionality for running services and limiting access by applications to the separated functionality for running services on the device.

7. The method of claim 1 wherein each mesh port is associated with a unique mesh port identifier.

8. The method of claim 1 wherein each specific application is associated with a unique application identifier and wherein causing the mesh service to determine whether the specific application is authorized for communications on the specific mesh port comprises:
receiving the application identifier from the specific application;
determining whether the application identifier matches an application identifier in a stored listing of authorized application identifiers and associated mesh ports in a memory location not accessible by the specific application.

9. The method of claim 8 wherein the application identifier comprises a digital signature.

10. The method of claim 1 wherein in response to receiving a data transmission at mesh service running on a specific device that is associated with a mesh port for an application that is not currently running on the device, causing the mesh service to forward the data transmission over the mesh network while preventing access to the data transmission by other applications running on the device.

11. The method of claim 1 wherein in response to receiving a data transmission at mesh service running on a specific device that is associated with a mesh port for a specific application that is currently running on the device, causing the mesh service to:
forward the data transmission to the application;
forward the data transmission over the mesh network to other devices.

12. The method of claim 1 wherein the wireless radio on each device is operable to communicate over the mesh network using any of a plurality of wireless transmission links, and further comprising causing the mesh service to provide access for receiving user preferences for enabling or disabling access to at least some of the plurality of wireless transmission links for mesh network communications.

13. The method of claim 1 wherein in response to receiving a data transmission at the mesh service on each device, determining whether the data transmission includes data related to controlling mesh network communications, and in response to determining that the data transmission includes data related to controlling mesh network communications, assigning the data transmission a higher transmission priority than other data transmissions.

14. The method of claim 13 wherein assigning the data transmission a higher transmission priority comprises assigning a highest transmission priority to data acknowledging receipt of previous transmissions by any of the plurality of devices, data associated with an application being launched on a device for accessing the mesh network, data associated with an application being terminated on a device.

15. The method of claim 1 wherein each specific application comprises a set of application interface codes for directing the processor circuit on the device to interface with the mesh service for transmission of data between the application and the mesh service.

16. The method of claim 1 wherein the mesh service is operable to provide debugging functionality for application developers developing applications using the mesh network, and further comprising causing the mesh service to limit the debugging functionality to application developers providing a valid developer key signature.
